(19) United States
(12) Patent Application Publication
(10) Pub. No.: US 2026/0342399 A1
(43) Pub. Date: Oct. 29, 2026

(54) CSI FEEDBACK FOR PORT ADAPTATION

(71) Applicant: Google LLC, Mountain View, CA (US)

(72) Inventor: Yushu Zhang, Beijing (CN)

(21) Appl. No.: 19/157,605

(22) PCT Filed: Feb. 22, 2023
(86) PCT No.: PCT/CN2023/077707

§ 371 Date: Aug. 18, 2025

(51) Int. Cl. H04B 7/06

(52) U.S. Cl. CPC H04B 7/0626; H04B 7/0632; H04B 7/0639

(57) ABSTRACT

This disclosure enables port adaptation for Multiple-Input-Multiple-Output (MIMO) communication based on channel conditions. A network entity (104) can transmit one or more channel state information (CSI) reference signal (CSI-RS) resources (110) to a UE (102). The UE can measure (112) the one or more CSI-RS resources and transmit one or more CSI reports (114) with port adaptation information (116) indicating CSI for one or more antenna port configurations. Antenna port configuration may refer to the quantity of antenna ports, polarity, and precoding matrix indicator (PMI). In some aspects, the UE reports the CSI for a UE-selected antenna port configuration having fewer or greater number of antenna ports than configured for the CSI-RS resource. In some aspects, the UE reports CSIs for a plurality of antenna port configurations to enable the network entity to select an antenna port configuration based on the reported CSIs.

### TECHNICAL FIELD

Aspects of the present disclosure relate generally to wireless communication, and to port adaptation based on channel conditions in a wireless communication system.

### BACKGROUND

Some wireless communication systems use multiple antennas and/or multiple data signals to transmit or receive data via one or more wireless channels. Multiple-Input Multiple-Output (MIMO) refers to a technology for multiplying the capacity of a wireless channel using multiple transmission and receiving antennas. In some instances, MIMO enables a network entity (such as a base station) and user equipment (UE) to communicate more than one data signal simultaneously over the same radio channel. The network entity configures the antenna port configuration using radio resource control (RRC) signaling. The antenna port configuration identifies the number of downlink transmission antenna ports and antenna structure. For example, the antenna port configuration can indicate the number of horizontal antenna ports N1 and the number of vertical antenna ports N2.

In addition to configuring the antenna port configuration, the network entity selects a digital precoder for the MIMO transmission. Typically, the network entity selects the digital precoder based on channel state information (CSI) that the network entity obtains from the UE in a CSI report. To enable CSI measurement, the network entity configures and transmits a reference signal for the UE to measure. For example, the network entity can configure a CSI report by radio resource control (RRC) signaling (such as the CSI-ReportConfig information element in an RRC message). The RRC signaling configures a channel state information reference signal (CSI-RS) that is used as channel measurement resource (CMR) for the UE to measure the downlink channel. Additionally, the network entity might configure some interference measurement resource (IMR) for UE to measure interference. Based on the configured CMR and IMR, the UE can measure the channel conditions and determine the CSI. The CSI might include at least one of a rank indicator (RI), a precoding matrix indicator (PMI), a channel quality indicator (CQI), or a layer indicator (LI). RI and PMI are used to indicate the digital precoder. CQI is used to indicate the signal-to-interference plus noise ratio (SINR) status so as to assist the network entity to determine the modulation and coding scheme (MCS). LI is used to identify the strongest layer for the reported precoder indicated by RI and PMI. The 3rd Generation Partnership Project (3GPP) standards setting body has defined the CSI measurement procedure and CSI report in technical specification (TS) standards documents. For example, 3GPP TS 38.212 defines the CSI report on PUCCH, 3GPP TS 38.212 defines the CSI report on PUSCH, and 3GPP TS 38.214 defines the procedure for CSI measurement and report based on Type 1 and Type 2 codebook.

The procedures for CSI measurement and report are based on a particular antenna port configuration set by the network entity. However, there might be instances in which the channel conditions could support a different antenna port configuration to reduce interference or reduce power consumption. Currently, there is no mechanism for a UE to obtain and report CSI for a different antenna port configuration.

### BRIEF SUMMARY

The systems, methods, and devices of this disclosure each have several innovative aspects, no single one of which is solely responsible for the desirable attributes disclosed herein.

One innovative aspect of the subject matter described in this disclosure can be implemented as a method of wireless communication at a user equipment (UE). The method includes receiving, via control signaling from a network entity, one or more channel state information (CSI) report configurations that indicate at least one CSI reference signal (CSI-RS) resource and that configures one or more CSI reports to include port adaptation information, receiving the at least one CSI-RS resource, and transmitting the one or more CSI reports with the port adaptation information based on measurements of the at least one CSI-RS resource, where the port adaptation information indicates at least one antenna port configuration and a respective CSI for the at least one antenna port configuration.

Another innovative aspect of the subject matter described in this disclosure can be implemented as a method of wireless communication at a network entity (such as a base station). The method includes transmitting, via first control signaling to a user equipment (UE), one or more channel state information (CSI) report configurations that indicate at least one CSI reference signal (CSI-RS) resource and that configures one or more CSI reports to include port adaptation information, transmitting the at least one CSI-RS resource, and receiving the one or more CSI reports with the port adaptation information, where the port adaptation information indicates at least one antenna port configuration and a respective CSI for the at least one antenna port configuration.

Another innovative aspect of the subject matter described in this disclosure can be implemented in an apparatus (such as a UE or a network entity). The apparatus includes a communication unit and a processing system. The processing system is configured to control the communication unit to implement any one of the above-referenced methods.

Details of one or more implementations of the subject matter described in this disclosure are set forth in the accompanying drawings and the description below. Other features, aspects, and advantages will become apparent from the description, the drawings, and the claims.

### BRIEF DESCRIPTION OF THE DRAWINGS

Note that the relative dimensions of the following figures may not be drawn to scale. Like reference numbers and designations in the various drawings indicate like elements.

FIG. 1 shows an example of a user equipment (UE) and network entity illustrating port adaptation according to some aspects of this disclosure.

FIG. 2 illustrates an example antenna structure for a 16-port network entity.

FIG. 3A illustrates an example procedure for channel state information (CSI) measurement and reporting that includes port adaptation information.

FIG. 3B illustrates an example procedure for CSI measurement and reporting in which the UE reports CSI for multiple CSI-RS resource combinations corresponding to different antenna port configurations.

FIG. 4A illustrates an example procedure for CSI measurement and reporting in which the network entity configures different number of antenna ports for CSI measurement.

FIG. 4B illustrates an example procedure for CSI measurement and reporting in which the network entity configures different number of antenna ports for CSI measurement and the UE reports CSI for multiple CSI-RS resource combinations corresponding to different antenna port configurations.

FIG. 5A illustrates an example procedure for CSI measurement and reporting in which the UE reports CSI for a subset of or all the antenna ports of a CSI-RS.

FIG. 5B illustrates an example procedure for CSI measurement and reporting in which the UE reports CSI for multiple antenna port groups from among the antenna ports of a CSI-RS.

FIG. 6 illustrates an example process for a UE that supports CSI-based port adaptation.

FIG. 7 illustrates an example process for a network entity that supports CSI-based port adaptation.

FIG. 8 illustrates an example antenna port configuration that includes a 4-port CSI-RS resources configuration for a 16-port network entity.

FIG. 9 illustrates another example antenna port configuration that includes a 4-port CSI-RS resources configuration for a 16-port network entity.

FIG. 10 illustrates an example CSI-RS configuration with different number of ports.

FIG. 11 illustrates another example CSI-RS configuration with different number of ports.

FIG. 12 illustrates an example set of CSI measurement hypotheses in which the CSI measurement hypotheses are based on different antenna ports from a CSI-RS resource.

FIG. 13 illustrates another example set of CSI measurement hypotheses in which the CSI measurement hypotheses are based on different antenna ports from a CSI-RS resource.

FIG. 14 illustrates an example CSI measurement in which the UE measures a subset of the antenna ports for a CSI-RS resource.

FIG. 15 illustrates another example CSI measurement in which the UE measures a subset of the antenna ports for a CSI-RS resource.

### DETAILED DESCRIPTION

The following description is directed to certain implementations for the purpose of describing the innovative aspects of this disclosure. However, a person having ordinary skill in the art will readily recognize that the teachings herein can be applied in a multitude of different ways. Some of the examples in this disclosure are based on wireless communication according to the 3rd Generation Partnership Project (3GPP) wireless standards, such as the 4th generation (4G) Long Term Evolution (LTE) and 5th generation (5G) New Radio (NR) standards. However, the described implementations can be implemented in any device, system, or network that is capable of transmitting and receiving radio frequency signals according to any of the wireless communication standards, including any of the Institute of Electrical and Electronics Engineers (IEEE) 802.11, 802.15, or 802.16 wireless standards, or other known signals that are used to communicate within a wireless, cellular, or internet of things (IoT) network, such as a system utilizing 3G, 4G, 5G, WiFi or future radio technology.

Various aspects of this disclosure relate to adapting an antenna port configuration based on channel conditions in a wireless communication system. The antenna port configuration refers to the quantity of antenna ports and polarization (such as the number of horizontal antenna ports N1 and number of vertical antenna ports N2) for a Multiple-Input Multiple-Output (MIMO) transmission. Typically, a network entity (such as a base station) configures the antenna port configuration and selects a digital precoder for the MIMO transmission. The network entity selects the digital precoder based on channel state information (CSI) that the network entity obtains from a user equipment (UE) in a CSI report. Current CSI measurement and report is based on a certain antenna port configuration. Absent the techniques of this disclosure, the UE cannot recommend an antenna port configuration for downlink transmission or report CSI for more than one antenna port configuration.

This disclosure provides systems, methods, and apparatuses for port adaptation based on channel conditions. Port adaptation refers to selection of a particular antenna port configuration based on CSI for more than one considered antenna port configuration. In this disclosure, a UE can provide one or more CSI reports with port adaptation information. The term “one or more CSI reports with port adaptation information” also may be referred to as “CSI-based port adaptation,” “port adaptation feedback information,” or “CSI feedback.” CSI feedback enables the UE to provide additional information to the network entity regarding CSI for one or more antenna port configurations that are different from an antenna port configuration set by the network entity.

Aspects of this disclosure enable a network entity to obtain one or more CSI reports with port adaptation information from a UE. The network entity can transmit a CSI report configuration indicating at least one CSI reference signal (CSI-RS) resource for the UE to measure. In some aspects, the CSI report configuration can indicate a list of CSI-RS resources. The list of CSI-RS resources may include resources from the same set of antennas or using different combinations of antennas and polarities. The UE can measure the one or more CSI-RS resources and transmit at least one CSI reports indicating the CSI for a particular CSI-RS and antenna port configuration. In some aspects, the UE can report the CSI for each of a plurality of antenna port configurations. In some implementations, a UE can use a codebook configuration or multiple codebook configurations to measure CSI for various CSI measurement hypotheses. Each CSI measurement hypothesis may be related to a different candidate antenna port configuration. After receiving the one or more CSI reports with port adaptation information, the network entity can select an antenna port configuration based on the CSI and port adaptation information. Aspects of this disclosure describe control signaling for CSI feedback and antenna port adaptation.

The techniques of this disclosure enable a network entity to adapt an antenna port configuration based on channel conditions. In some instances, the network entity can select an antenna port configuration (or a UE can recommend an antenna port configuration) that improves operation of the wireless communication system. For example, antenna port adaptation can have one or more advantageous effects such as reducing interference from downlink MIMO transmissions, reducing power consumption, or improving channel efficiency, among other examples.

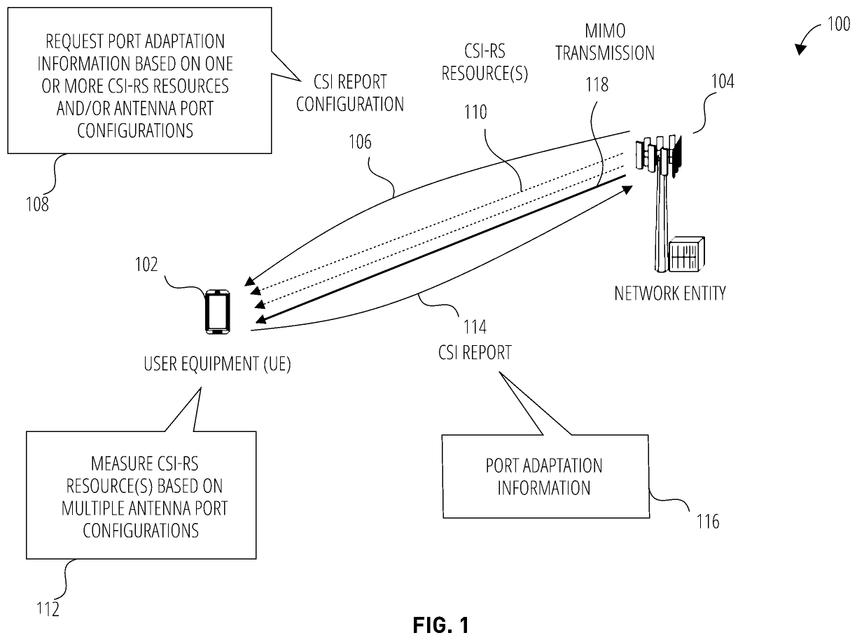

FIG. 1 shows an example of a user equipment (UE) and network entity illustrating port adaptation according to some aspects of this disclosure. The diagram 100 shows a UE 102 and a network entity 104 of a wireless communication system. The network entity 104 can be a base station. Different types of base stations might be referred to as a NodeB, an LTE evolved NodeB (eNB), a next generation NodeB (gNB), an access point (AP), a radio head, a transmit-receive point (TRP), among other examples, depending on the wireless communication standard that the base station supports. The network entity 104 is configured to use MIMO communication in which multiple antenna ports are used to transmit signals to the UE 102. The network entity 104 selects an antenna port configuration and digital precoder for the MIMO transmission 118 and configures the antenna port configuration in an RRC message before transmitting the MIMO transmission 118. The network entity 104 can use CSI to select the digital precoder.

An example CSI measurement and report technique is described with reference to FIG. 1. Generally, the network entity 104 transmits a CSI report configuration 106 by RRC signaling, such as CSI-ReportConfig, to configure a CSI report. The CSI report configuration 106 can indicate channel state information reference signal (CSI-RS) resources 110 for the UE 102 to measure the downlink channel conditions. By measuring the CSI-RS resources 110, the UE 102 is able to identify the CSI, which might include at least one of rank indicator (RI), precoding matrix indicator (PMI), channel quality indicator (CQI) and layer indicator (LI). RI and PMI are used to indicate the digital precoder. CQI is used to indicate the signal-to-interference plus noise (SINR) status so as to assist the network entity to determine the modulation and coding scheme (MCS). LI is used to identify the strongest layer for the reported precoder indicated by RI and PMI. The UE 102 measures the CSI-RS resources and reports CSI to the network entity 104 in a CSI report. The network entity 104 can use the CSI (such as PMI, RI, LI) to select the digital precoder and layer for the MIMO transmission 118.

In existing systems, the UE 102 only reports CSI based on the configured CSI-RS resource and a certain number of downlink transmission antenna ports and antenna structure that the network entity 104 configures by RRC signaling. The UE 102 would typically only measure the CSI-RS resource using the configured antenna ports. However, there may be instances in which fewer antenna ports (than those configured by the network entity) could provide similar throughput gain while reducing interference to another UE and reducing the power consumption for the network entity. Absent the techniques of this disclosure, the network entity 104 cannot be informed of the CSI that would be possible using a different antenna port configuration.

In some aspects, the network entity 104 can transmit a CSI report configuration 106 that requests port adaptation based on one or more CSI-RS resources and/or antenna port configurations 108. In some aspects, the CSI report configuration 106 can indicate multiple CSI-RS resource configurations for the UE 102 to measure using different antenna port configurations. In some aspects, the network entity 104 can configure CSI-RS resources that cover multiple antenna port combinations of the same quantity of antenna ports or different quantities of antenna ports.

At block 112, the UE 102 can measure the one or more CSI-RS resources 110 using different antenna port configurations. The UE 102 can report CSI for one or more antenna port configurations. For example, the CSI report 114 can be modified to include port adaptation information that indicates an antenna port configuration that corresponds to the reported CSI.

In some implementations, the UE 102 can report the CSI for a single CSI measurement hypothesis, such as the CSI that corresponds to the antenna port configuration providing the highest spectrum efficiency among the measured CSI for multiple antenna port configurations. In some other implementations, the UE 102 can report multiple CSIs so that the UE 102 can inform the network entity 104 of the CSI that corresponds to various antenna port configurations.

In addition to configuring one or more CS-RS resources 110, the network entity 104 can also inform the UE 102 regarding one or more codebooks that will be used for the MIMO transmission 118. In this regard, the UE 102 can report the PMI, RI, and LI (in some implementations) along with the CSI. In implementations where the UE 102 reports multiple CSIs (corresponding to different antenna port configurations), the one or more CSI reports 114 can include a separate CSI report for each CSI or a single CSI report containing an aggregation of CSI for multiple antenna port configurations. This disclosure describes CSI reporting schemes in which PMI, RI, and LI can be reported efficiently based on the type of codebook and how many CSIs are reported to the network entity 104.

In some aspects of this disclosure, the network entity 104 can configure a single CSI-RS resource in the CSI report configuration 106 and the UE 102 can measure and report CSI based on one or more subsets of antenna ports (and/or all antenna ports) from the configured CSI-RS resource. The UE can measure multiple CSI measurement hypotheses based on the single CSI-RS resource and report CSI for a CSI measurement hypothesis having a different number of ports than the configured ports for the single CSI-RS resource. This enables the UE 102 to report CSI for an antenna port configuration that differs from the configured antenna ports for the single CSI-RS resource. Based on the reported CSI, the network entity 104 can dynamically update the number of antenna ports for the MIMO transmission 118. The network entity 104 can update the antenna port configuration using a media access control (MAC) control element (CE) or DCI before the MIMO transmission 118.

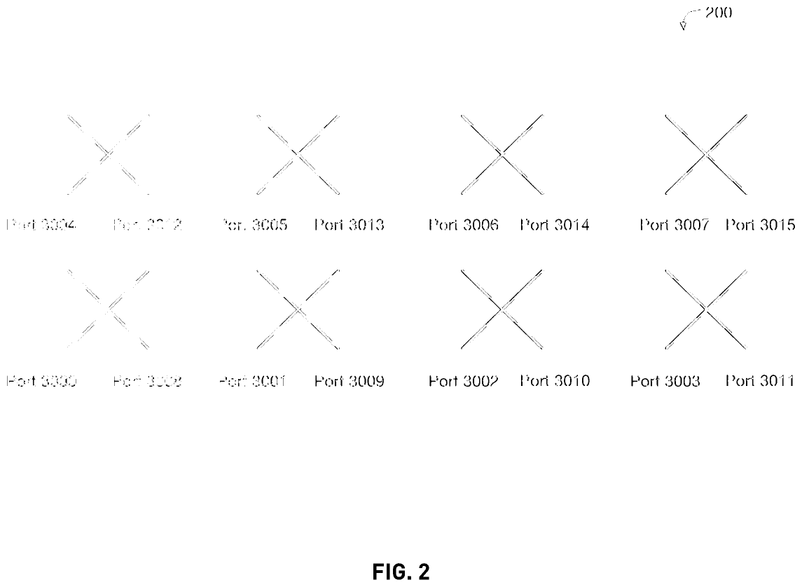

FIG. 2 illustrates an example antenna structure 200 for a 16-port network entity. The network entity configures the number of horizontal antenna ports N1 and the number of vertical antenna ports N2. In FIG. 2, the antenna port configuration of (N1, N2)=(4, 2) for a dual-polarization antenna. FIG. 2 shows 16 ports (numbered 3000 to 3015). Absent the techniques of this disclosure, the network entity would transmit CSI-RS resources based on the 16 ports of the antenna structure 200. The UE would measure the CSI based on the 16-port antenna port configuration and report CSI for only that preconfigured antenna port configuration.

Sometimes, more antenna ports cannot always provide performance gain for some UEs. Table 1 illustrates the system level simulation results for the user throughput gain statistic for 32 ports case compared to the 16 ports case based on single-user MIMO (SU-MIMO) scheduling. It can be observed that more antenna ports cannot provide performance gain for 46.19% users.

TABLE 1
User throughput gain statistic for 32 ports
SU-MIMO compared to 16 ports SU-MIMO

| User throughput gain | User percentage |
|---|---|
| 0% gain | 46.19% |
| <=5% gain | 61.90% |
| <=10% gain | 71.43% |
| <=15% gain | 80.48% |
| <=20% gain | 86.19% |

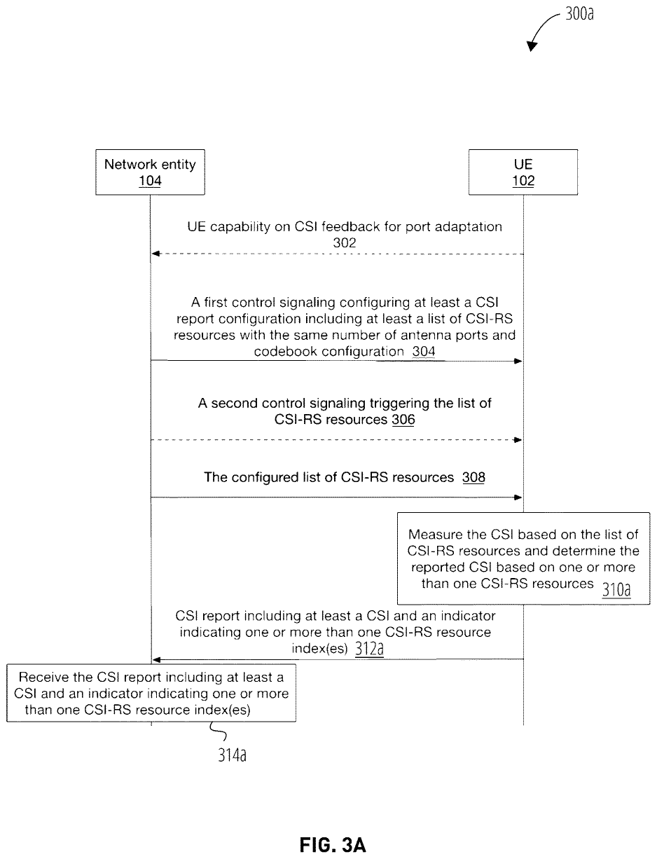

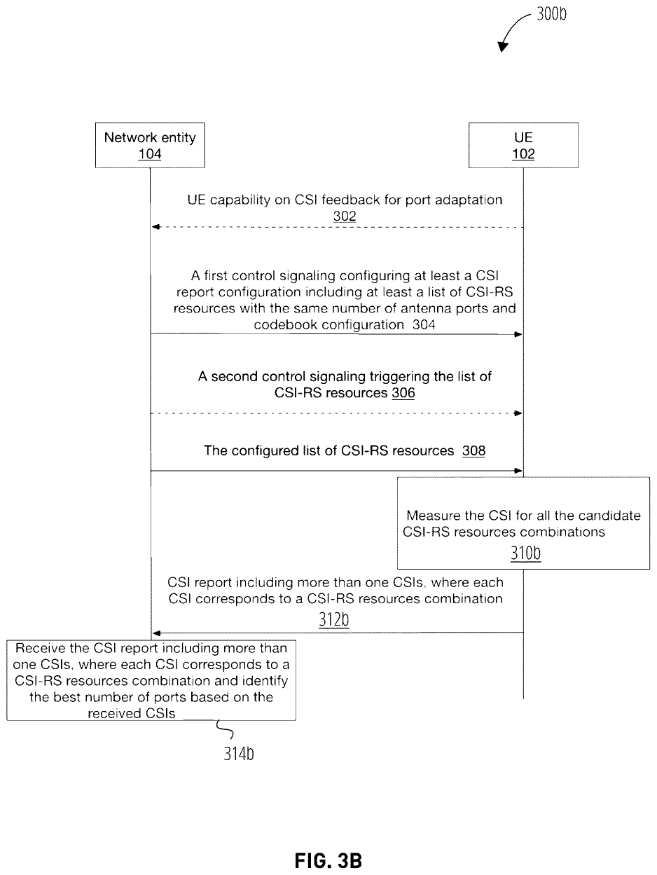

FIG. 3A illustrates an example procedure 300a for channel state information (CSI) measurement and reporting that includes port adaptation information. FIG. 3A shows operations of a network entity 104 and a UE 102, which may be same or similar to the network entity 104 and the UE 102, respectively, as described with reference to FIG. 1. In some implementations, the operations of the network entity 104 can be implemented by any network entity, or any component thereof. In some implementations, the operations of the UE 102 can be implemented by any UE, or any component thereof.

The UE 102 may report the UE capabilities 302 at least indicating whether it supports CSI-based port adaptation. Based on the received UE capabilities, the network entity 104 transmits a first control signaling 304 configuring at least one CSI report configuration including a list of CSI-RS resources with the same number of antenna ports and a codebook configuration. In some other implementations, the network entity 104 transmits a first control signaling configuring a list of CSI-RS resources with the same number of antenna ports in more than one CSI report configuration. The network entity 104 may transmit the first control signaling by RRC signaling, such as RRCReconfiguration or CSI-ReportConfig. In some implementations, for semi-persistent CSI-RS and/or CSI report or aperiodic CSI-RS and/or CSI report, the network entity 104 may transmit a second control signaling 306, such as MAC CE or DCI, triggering the CSI-RS and/or CSI report. Then the network entity 104 may transmit the configured list of CSI-RS resource 308 for CSI measurement and report. The UE 102 can determine the CSI based on one or more than one CSI-RS resources (shown at block 310a). The UE 102 transmits the CSI report 312a including at least one CSI and an indicator indicating one or more than one CSI-RS resource index(es). The UE 102 may transmit the CSI on a physical uplink control channel (PUCCH) or physical uplink shared channel (PUSCH). At block 314a, the network entity 104 receives the CSI report including at least a CSI and an indicator indicating one or more than one CSI-RS resource index(es) (CRIs). The CRIs correspond to CRS-RS resources on various antenna ports. Using the reported CSI and CRIs, the network entity 104 can determine which antenna ports to use for a subsequent MIMO transmission (not shown) to the UE 102. The network entity 104 can update the antenna port configuration (via MAC CE or DCI) to inform the UE 102 of the selected antenna ports that will be used for the subsequent MIMO transmission (such as MIMO transmission 118 described with reference to FIG. 1).

FIG. 3B illustrates an example procedure 300b for CSI measurement and reporting in which the UE reports CSI for multiple CSI-RS resource combinations corresponding to different antenna port configurations. FIG. 3B shows operations of a network entity 104 and a UE 102, which may be same or similar to the network entity 104 and the UE 102, respectively, as described with reference to FIG. 1. In some implementations, the operations of the network entity 104 can be implemented by any network entity, or any component thereof. In some implementations, the operations of the UE 102 can be implemented by any UE, or any component thereof.

Compared to the procedure in FIG. 3A, the difference is that in FIG. 3B, the UE 102 measures the CSI for multiple or all candidate CSI-RS resources combinations (shown at block 310b). Each candidate CSI-RS resource combination can include a different set of antenna ports within the configured CSI-RS resources. Each reported CSI corresponds to a particular candidate CSI-RS resource combination. At block 312b, the UE 102 transmits a CSI report (or multiple CSI reports) to indicate more than one CSI, where each CSI corresponds to a CSI-RS resources combination. At block 314b, the network entity 104 receives the CSI report (or multiple CSI reports) and identifies the best number of ports based on the received CSIs. The network entity 104 can determine the antenna ports for the subsequent downlink MIMO transmission (such as MIMO transmission 118 described with reference to FIG. 1).

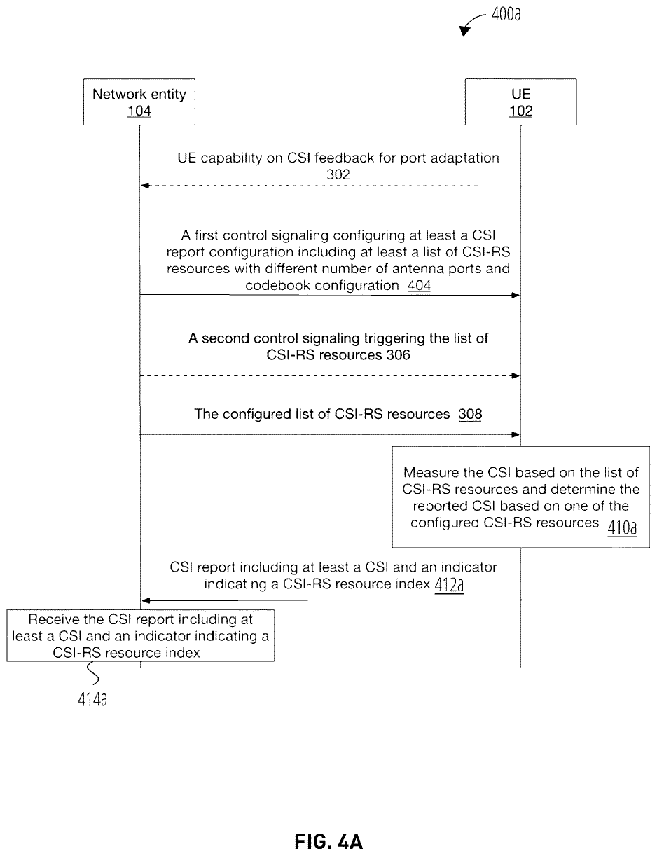

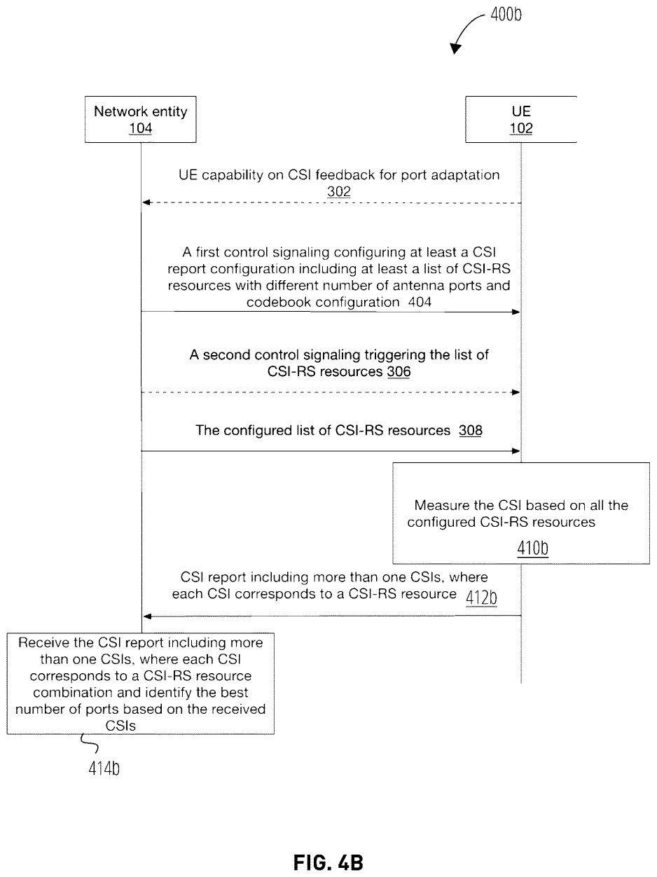

FIG. 4A illustrates an example procedure 400a for CSI measurement and reporting in which the network entity configures a different number of antenna ports for CSI measurement. FIG. 4AA shows operations of a network entity 104 and a UE 102, which may be same or similar to the network entity 104 and the UE 102, respectively, as described with reference to FIG. 1. In some implementations, the operations of the network entity 104 can be implemented by any network entity, or any component thereof. In some implementations, the operations of the UE 102 can be implemented by any UE, or any component thereof.

Compared to the procedure in FIG. 3A, the difference is that in FIG. 4A, the network entity 104 transmits first control signaling 404 configuring at least a CSI report configuration including a list of CSI-RS resources with different number of antenna ports and codebook configuration. At block 410a, the UE 102 measures the CSI based on the list of CSI-RS resources and determines the reported CSI based on one of the configured CSI-RS resources. In FIG. 4A, the UE might only identify one CSI-RS resource for the CSI report 412b. The UE transmits the CSI report 412b including at least one CSI and an indicator indicating one CSI-RS resource index. At block 414a, the network entity 104 receives the CSI report including at least a CSI and an indicator indicating a CSI-RS resource index. Thereafter, the network entity 104 can select an antenna port configuration based on the CSI and use the selected antenna port configuration for a subsequent MIMO transmission (such as MIMO transmission 118 described with reference to FIG. 1).

FIG. 4B illustrates an example procedure 400b for CSI measurement and reporting in which the network entity configures different number of antenna ports for CSI measurement and the UE reports CSI for multiple CSI-RS resource combinations corresponding to different antenna port configurations. FIG. 4B shows operations of a network entity 104 and a UE 102, which may be same or similar to the network entity 104 and the UE 102, respectively, as described with reference to FIG. 1. In some implementations, the operations of the network entity 104 can be implemented by any network entity, or any component thereof. In some implementations, the operations of the UE 102 can be implemented by any UE, or any component thereof.

Compared to the procedure in FIG. 4A, the difference is that in FIG. 4B, the UE 102 measures the CSI based on multiple or all configured CSI-RS resources (block 410b), and transmits a CSI report 412b having more than one CSIs, where each CSI corresponding to a different CSI-RS resource combination. At block 414b, the network entity 104 receives the CSI report including more than one CSIs and identifies the best number of ports based on the received CSIs. The best number of ports may be the minimum quantity of ports (from among the quantities of ports for various CSI-RS resources combinations) that has a suitable quality of service and spectrum efficiency, or both. After receiving the CSIs, the network entity can determine the antenna ports for a subsequent downlink MIMO transmission (such as MIMO transmission 118 described with reference to FIG. 1)

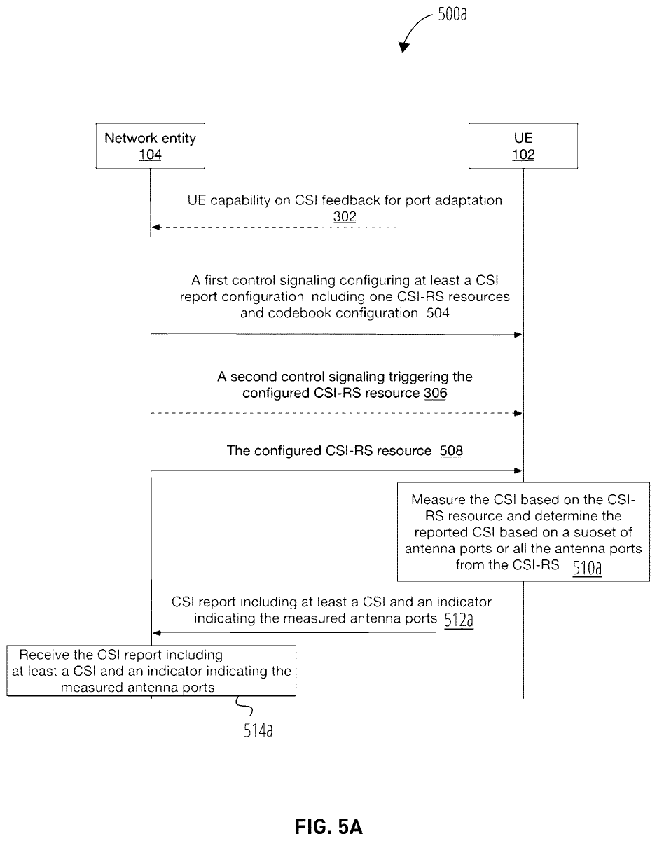

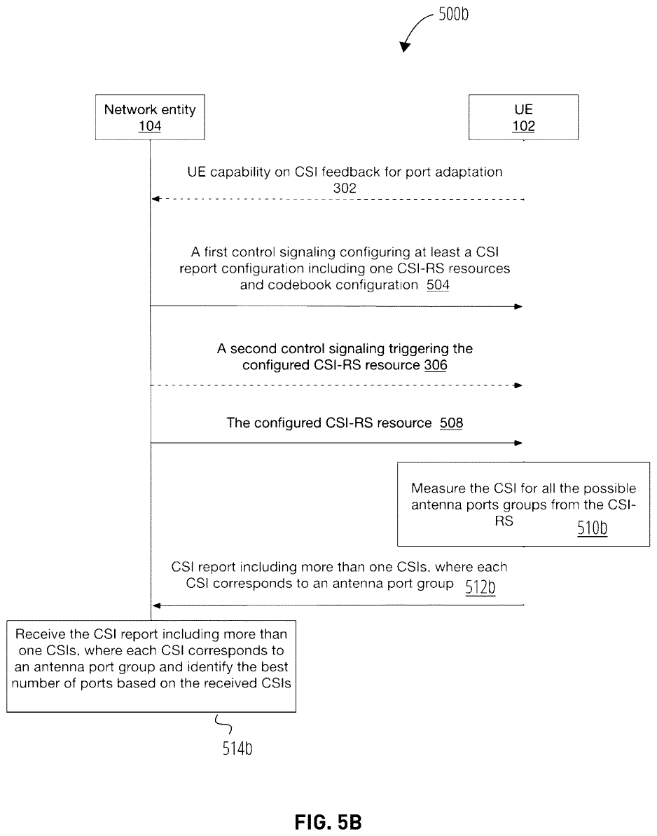

FIG. 5A illustrates an example procedure 500a for CSI measurement and reporting in which the UE reports CSI for a subset of or all the antenna ports of a CSI-RS. FIG. 5A shows operations of a network entity 104 and a UE 102, which may be same or similar to the network entity 104 and the UE 102, respectively, as described with reference to FIG. 1. In some implementations, the operations of the network entity 104 can be implemented by any network entity, or any component thereof. In some implementations, the operations of the UE 102 can be implemented by any UE, or any component thereof.

Compared to the procedure in FIG. 3A, the difference is that in FIG. 5A, the network entity 104 configures a single CSI-RS resource and codebook configuration in the first control signaling 504, and the UE 102 can measure CSI using a subset of or all the antenna ports for the CSI-RS resource (block 510a). The UE 102 transmits the CSI report 512a including at least one CSI and an indicator indicating the measured antenna ports for the CSI. At block 514a, the network entity 104 receives the CSI report including at least a CSI and an indicator indicating the measured antenna ports. The network entity 104 can use the reported CSI and indicator to determine an antenna port configuration for a subsequent downlink MIMO transmission (such as MIMO transmission 118 described with reference to FIG. 1).

FIG. 5B illustrates an example procedure 500b for CSI measurement and reporting in which the UE reports CSI for multiple antenna port groups from among the antenna ports of a CSI-RS. FIG. 5B shows operations of a network entity 104 and a UE 102, which may be same or similar to the network entity 104 and the UE 102, respectively, as described with reference to FIG. 1. In some implementations, the operations of the network entity 104 can be implemented by any network entity, or any component thereof. In some implementations, the operations of the UE 102 can be implemented by any UE, or any component thereof.

Compared to the procedure in FIG. 5A, the difference is that in FIG. 5B, the UE 102 measures the CSI for multiple or all possible antenna port groups from the CSI-RS resource (block 510b) and transmits a CSI report 512b including more than one CSIs, where each CSI corresponds to an antenna ports group from the configured antenna ports for the CSI-RS resource. At block 514b, the network entity 104 receives the CSI report including more than one CSIs. The network entity 104 can use the reported CSIs to determine an antenna port configuration for a subsequent downlink MIMO transmission (such as MIMO transmission 118 described with reference to FIG. 1).

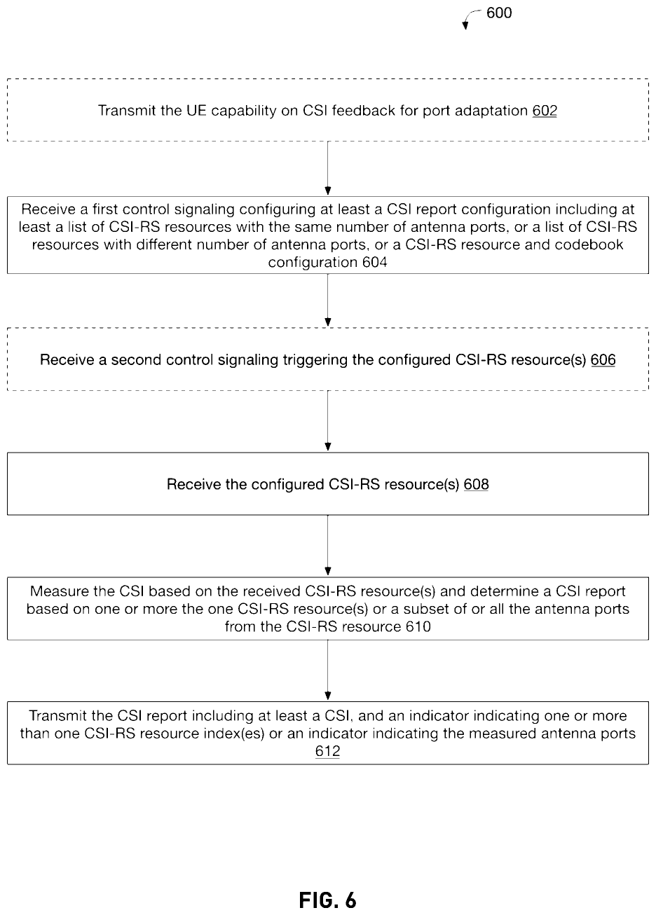

FIG. 6 illustrates an example process 600 for a UE that supports CSI-based port adaptation. In some implementations, the operations of the example process 600 can be implemented by a UE, or any component thereof, such as the UE 102 described with reference to FIG. 1. At block 602, the UE may transmit the UE capability on CSI-based port adaptation. At block 604, the UE receives a first control signaling configuring at least a CSI report configuration including at least a list of CSI-RS resources with the same number of antenna ports, or a list of CSI-RS resources with different number of antenna ports, or a CSI-RS resource and codebook configuration. At block 606, the UE may receive a second control signaling triggering the configured CSI-RS resource(s). At block 608, the UE receives the configured CSI-RS resource(s). At block 610, the UE measures the CSI based on the received CSI-RS resource(s) and determines a CSI report based on one or more than one CSI-RS resource(s) or a subset of or all the antenna ports from the CSI-RS resource. At block 612, the UE transmits the CSI report including at least a CSI, and an indicator indicating one or more than one CSI-RS resource index(es) or an indicator indicating the measured antenna ports.

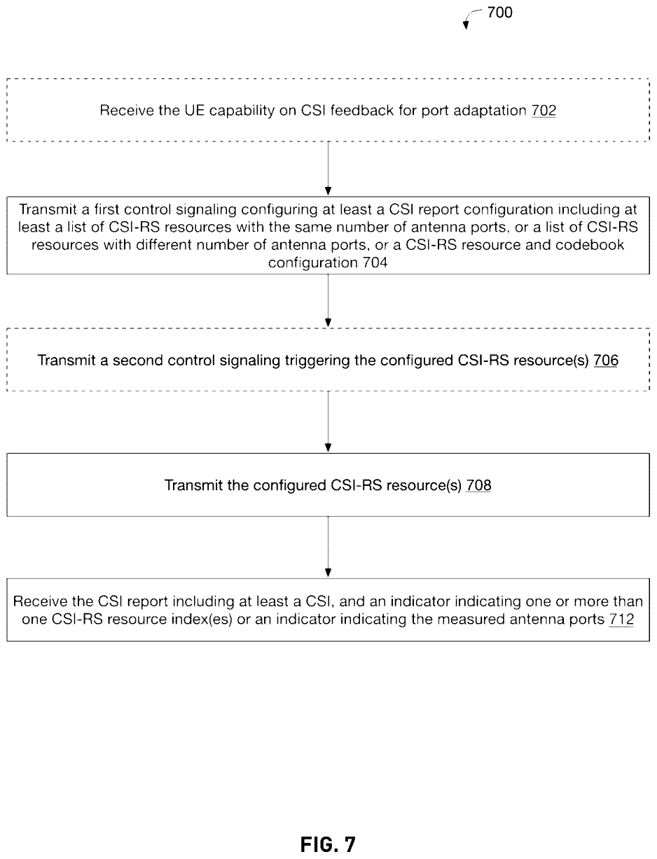

FIG. 7 illustrates an example process 700 for a network entity that supports CSI-based port adaptation. In some implementations, the operations of the example process 700 can be implemented by a network entity, or any component thereof, such as the network entity 104 described with reference to FIG. 1. At block 702, the network entity may receive the UE capability on CSI feedback for port adaptation. At block 704, the network entity transmits a first control signaling configuring at least a CSI report configuration including at least a list of CSI-RS resources with the same number of antenna ports, or a list of CSI-RS resources with different number of antenna ports, or a CSI-RS resource and codebook configuration. At block 706, the network entity may transmit a second control signaling triggering the configured CSI-RS resource(s). At block 708, the network entity transmits the configured CSI-RS resource(s). At block 712, the network entity receives the CSI report including at least a CSI, and an indicator indicating one or more than one CSI-RS resource index(es) or an indicator indicating the measured antenna ports.

### UE Capability

In some implementations, the UE may transmit the UE capability on CSI-based port adaptation indicating at least one of the elements: whether the UE supports CSI-based port adaptation; the maximum number of configured CSI-RS resources for CSI-based port adaptation; the maximum number of CSI-RS resources in a slot for CSI-based port adaptation; the supported antenna ports configurations for CSI report; the supported codebook type for the CSI-based port adaptation. The UE capabilities above may be counted per component carrier (CC), across all the CCs in a band or band combination, or across all the CCs in a UE.

Here, unless specified, the network entity may receive the UE capability from a UE or from a core network (such as Access and Mobility Management Function (AMF)) or another network entity.

Here, unless specified, a RRC signaling may indicate a RRC reconfiguration message from network entity to UE, or a System Information Block (SIB), where the SIB can be an existing SIB (such as SIB1) or a new SIB (such as SIB J, where J is an integer above 21) transmitted by a network entity.

This disclosure describes several example implementations of CSI-based port adaptation, such as the example implementations described with reference to FIG. 1, FIG. 3A, FIG. 3B, FIG. 4A, FIG. 4B, FIG. 5A, FIG. 5B, FIG. 6, and FIG. 7. This disclosure includes additional detail regarding the previously described example implementations as well as several additional example implementations. For ease of reference, the various example implementations can be referred to as options. Some options include various techniques as to how many CSI-RS resources configurations are sent by the network entity in CSI report configurations and how many CSIs the UE transmits in one or more CSI reports to the network entity. Furthermore, some options relate processing various codebook configurations when considering antenna port configurations or generating port adaptation information for CSI-based port adaptation. Below is a reference list identifying the described example implementation options:

### Option 1: CSI Report Based on Multiple Aggregated CSI-RS Resources

Option 1-1a: CSI report for single CSI measurement hypothesis
Option 1-1b: CSI report for multiple CSI measurement hypothesis
Option 1-2a: PMI report based on a Type1 single-panel codebook configuration
Option 1-2b: PMI report based on a Type1 multi-panel codebook configuration
Option 1-2c: PMI report based on a Type2 codebook configuration
Option 1-2d: PMI report based on an enhanced Type2 (eType2) codebook configuration
Option 1-2e: PMI report based on a set of codebook configuration.
   Option 2: CSI Report Based on CSI-RS Resources with Different Number of Ports
Option 2-1a: CSI report for single CSI measurement hypothesis
Option 2-1b: CSI report for multiple CSI measurement hypothesis
Option 2-2a: PMI report based on a codebook configuration
Option 2-2b: PMI report based on multiple codebook configurations

### Option 3: CSI Report Based on a Single CSI-RS Resource

Option 3-1a: CSI report for single CSI measurement hypothesis
Option 3-1b: CSI report for multiple CSI measurement hypothesis
Option 3-2a: PMI report based on a codebook configuration
Option 3-2b: PMI report based on multiple codebook configurations

Although described separately, the concepts described in each option are not exclusive, and some implementations can combine some concepts from multiple ones of the described options.

### Option 1: CSI Report Based on Multiple Aggregated CSI-RS Resources

In some implementations, the network entity configures a list of CSI-RS resources in a CSI report configuration or multiple CSI report configuration, where the network entity configures the CSI-RS resources with the same number of antenna ports, and the CSI-RS resources share the same quasi-co-location (QCL) properties, including a subset of or all the QCL parameters: {Doppler shift, Doppler spread, average delay, delay spread, Spatial receiving (Rx) parameter, antenna gain}. In some implementations, the network entity configures the CSI-RS resources with the same bandwidth, frequency domain density, and/or periodicity. In some implementations, the network entity transmits the CSI-RS resources in the same slot or in more than one consecutive slot. Then the UE can measure the CSI based on aggregated CSI-RS resources.

### Option 1-1a: CSI Report for Single CSI Measurement Hypothesis

In some implementations, the UE reports the CSI based on a single CSI measurement hypothesis, i.e., a set of CSI-RS resources.

In some implementations, the UE reports the CSI including a list of CRIs indicating the selected CSI-RS resources. In one example, the UE reports a bitmap indicating the selected CSI-RS resource, where value “1” for bit x may indicate the CSI-RS resource x in the configured list of CSI-RS resources is selected and value “0” for bit x may indicate the CSI-RS resource x in the configured list of CSI-RS resources is not selected.

In some other implementations, the UE reports the CSI including an indicator indicating the number of selected CRIs. Then the CSI-RS resources {1, 2, . . . , K} are selected, where K indicates the reported number of selected CRIs.

In some other implementations, the network entity configures the candidate CRI groups by the first control signaling or a MAC CE or DCI. In one example, the network entity may configure 3 groups: {CRI 1}, {CRI 1 and 2}, {CRI 1, 2, 3 and 4}. The UE reports the CSI including an indicator indicating the selected CRI group index.

In some implementations, the network entity may further configure the maximum or minimum number of selected CSI-RS resources by the first control signaling.

In some implementations, the UE measures and reports at least one of the CQI, RI and LI based on the reported CSI-RS resources.

In some implementations, the UE determines the reported CSI-RS resources based on the spectrum efficiency and the number of CSI-RS resources. In one example, the UE selects the CSI-RS resources that can produce the highest spectrum efficiency based on the reported CQI and RI, where the spectrum efficiency indicated by CQI and RI can be calculated using formula (1) as follows:

SE=SE_{CQI}N_{L} (1)

Where SE_{CQI} is the spectrum efficiency (SE) indicated by CQI, and N_{L} is the number of layers indicated by RI. For the CSI-RS resources that can produce the same SE, the UE selects the CSI-RS resources with a smaller number of total antenna ports.

In some other implementations, the network entity configures a target spectrum efficiency. The UE determines the reported CSI-RS resources based on the target spectrum efficiency and the number of CSI-RS resources. In one example, the UE selects the CSI-RS resources with the smallest number of total antenna ports that can produce the SE higher than or equal to the target spectrum efficiency.

### Option 1-1b: CSI Report for Multiple CSI Measurement Hypothesis

In some implementations, the UE reports multiple CSIs based on multiple CSI measurement hypothesis, where each CSI corresponds to a CSI measurement hypothesis, i.e., a set of CSI-RS resources.

In some implementations, the UE reports the CSI for different number of CSI-RS resources. In one example, if the network entity configures 4 CSI-RS resources, the UE reports 4 CSIs corresponding to 1, 2, 3, 4 CSI-RS resources respectively.

In some other implementations, the network entity configures the candidate CSI-RS resources combination groups by the first control signaling, and the UE reports the CSI for each CSI-RS resource combination group. In one example, the network entity may configure 3 groups: {CRI 1}, {CRI 1 and 2}, {CRI 1, 2, 3 and 4}. The UE reports the 3 CSIs, and each CSI corresponds to a group.

In some implementations, the UE reports a common RI and PMI based on the candidate CSI-RS resources combination group with the largest number of CSI-RS resources. The network entity can derive the PMI for other CSI-RS resources combination based on the CSI-RS resource in the combination RI and PMI. In some other implementations, the UE reports separate RI for each CSI and a common full rank PMI based on the candidate CSI-RS resources combination group with the largest number of CSI-RS resources. Then the network entity can derive the precoder for a CSI-RS resource group as a sub-matrix from the precoder indicated by the PMI based on the antenna port index(es) and the reported RI for the CSI-RS resource group.

In one example, the precoder indicated by the full rank PMI could be a KNₚ×Nₗ^{max} matrix, where K is the maximum number of CSI-RS resources in a CSI-RS resource combination group, Nₚ is the number of antenna ports per CSI-RS resource, Nₗ^{max} is the maximum number of layers. For a CSI-RS resource group with X resource, such as {CRI 1, CRI 2, . . . , CRI X} with RI=r, the precoder can be the first XNₚ rows from the first r columns from the precoder indicated by the full rank PMI with normalization.

In some other implementations, the UE reports separate RI and PMI for each CSI-RS resources combination group.

In some implementations, the UE reports absolute CSI for each CSI-RS resources combination group. In some other implementations, the UE reports absolute CSI for the CSI-RS resources combination group with the largest number of resources, and reports differential CSI for the other CSI-RS resources combination groups. In one example, the UE reports a common RI for all the CSI-RS resource groups combinations and absolute CQI for the CSI-RS resources combination group with the largest number of resources, and reports differential CQI for the other CSI-RS resources combination group with the absolute CQI as reference.

In some implementations, the network entity configures the CSI report scheme for the multi-CSI report for port adaptation by the first control signaling or the second control signaling. Table 2 illustrates an example for the CSI report schemes for multi-CSI report.

TABLE 2
An example for the CSI report schemes for multi-CSI report

| | RI | CQI | PMI |
|---|---|---|---|
| Scheme 1 | Hypothesis- | Hypothesis- | Hypothesis- |
| | specific | specific | specific |
| Scheme 2 | Hypothesis- | Hypothesis- | Hypothesis- |
| | common | specific | common |
| Scheme 3 | Hypothesis- | Hypothesis- | Hypothesis- |
| | specific | specific | common (full |
| | | | rank PMI based |
| | | | on the largest |
| | | | number of ports) |
| Scheme 4 | Hypothesis- | Hypothesis- | Hypothesis- |
| | common | specific | specific |

### Option 1-2a: PMI Report Based on a Type1 Single-Panel Codebook Configuration

In some implementations, the network entity configures a type1 single-panel codebook for a CSI-RS resource by the first control signaling. In one example, the network entity configures the codebookConfig with the codebookType set as type1-SinglePanel. Then the UE can measure and report the PMI based on the configured Type1 single-panel codebook based on the estimated channel from one of the CSI-RS resources or the average estimated channel from multiple CSI-RS resources. The UE can measure and report the antenna combining factor, such as co-phasing, between the CSI-RS resources.

Option 1-2a-1: PMI+Antenna Combining Factor Report

In some implementations, the UE reports a common antenna combining factor across the CSI-RS resources. Then the reported precoder for K reported CSI-RS resources can be as follows (formula (2)):

$$W = [ \begin{matrix}\tilde{W} \\ \tilde{W} {C}_{1} \\ ⋮ \\ \tilde{W} {C}_{K - 1} \\ \tilde{W} {C}_{k}\end{matrix} ] \qquad ( 2 )$$

Where \tilde{W} is the precoder indicated by the PMI based on the configured Type1 single-panel codebook with the dimension of Nₚ×Nₗ; Nₚ is the number of antenna ports per CSI-RS resource; Nₗ is the number of layers indicated by the reported RI; Cₖ is the antenna combining factor across the CSI-RS resources, which is as follows (formula (3)):

$${C}_{k} = [ \begin{matrix}{e}^{j \frac{2 π {kN}_{p}}{{N}_{c}} {n}_{1}} & … & 0 \\ ⋮ & ⋱ & ⋮ \\ 0 & … & {e}^{j \frac{2 π {kN}_{p}}{{N}_{c}} {{n}_{N}}_{1}}\end{matrix} ] \qquad ( 3 )$$

Where N_{c} may be predefined or configured by the network entity; the UE reports indicators indicating the n₁, . . . , n_{N}_{ₗ} in addition to the PMI for the CSI report. The candidate value of n may be predefined or configured by the RRC signaling from the network entity. In some implementations, n₁=n₂= . . . =n_{N}_{ₗ}, and the UE reports a common antenna combining factor for all layers.

In some other implementations, the UE reports different antenna combining factor between different CSI-RS resources. Then the antenna combining factor Cₖ is calculated as follows (formula (4)):

$${C}_{k} = [ \begin{matrix}{e}^{j \frac{2 π}{{N}_{c}} {n}_{k , 1}} & … & 0 \\ ⋮ & ⋱ & ⋮ \\ 0 & … & {e}^{j \frac{2 π}{{N}_{c}} {{n}_{k , N}}_{1}}\end{matrix} ] \qquad ( 4 )$$

The UE reports indicators indicating the n_{1,1}, . . . , n_{1,N}_{ₗ}, . . . , n_{K-1,1}, . . . , n_{K-1,N}_{ₗ} in addition to the PMI for the CSI report. In some implementations, n_{k,1}=n_{k,2}= . . . =n_{k,N}_{ₗ}, and the UE reports a common antenna combining factor for all layers for a CSI-RS resource k.

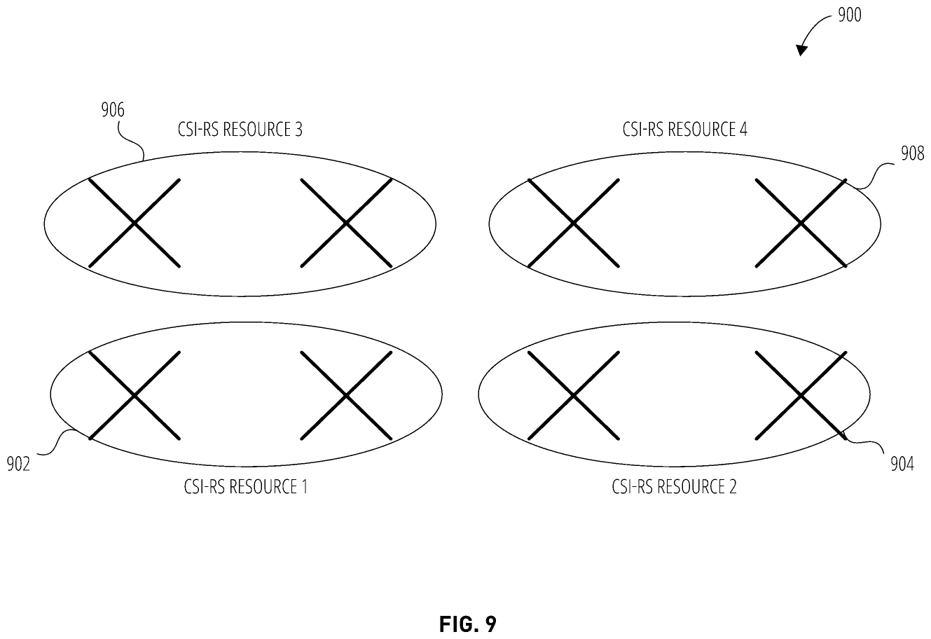

In some implementations, the network entity configures whether the UE should report the PMI based on a common antenna combining factors between the CSI-RS resources or not by the first control signaling. In some other implementations, the network entity configures the CSI-RS resources groups that share the same antenna combining factors by the first control signaling. In one example, if the network entity configures the CSI-RS antenna ports as described with reference to FIG. 9, the network entity may configure the CSI-RS resource 1 and 2, CSI-RS resource 3 and 4 share common antenna combining factors, and CSI-RS resource 1 and 3, CSI-RS resource 2 and 4 share common antenna factors. In some implementations, the network entity may configure whether the UE reports layer-specific antenna combining factor or layer-common antenna combining factor by the first control signaling.

Option 1-2a-2: PMI Report Based on a Reconstructed Codebook

In some implementations, the UE reports a PMI based on a reconstructed codebook, where the UE reconstructs the codebook based on the selected CSI-RS resources and the codebook configuration for a CSI-RS resource.

In some implementations, the network entity configures the antenna port(s) index in the full antenna grid for each CSI-RS resource by the RRC signaling, and then the UE can identify the number of antenna ports in horizontal and vertical domain (N1, N2) for the aggregated CSI-RS resources. In some other implementations, the network entity configures the spatial domain multiplexing scheme for a CSI-RS resource based on a reference CSI-RS resource or for every two CSI-RS resource.

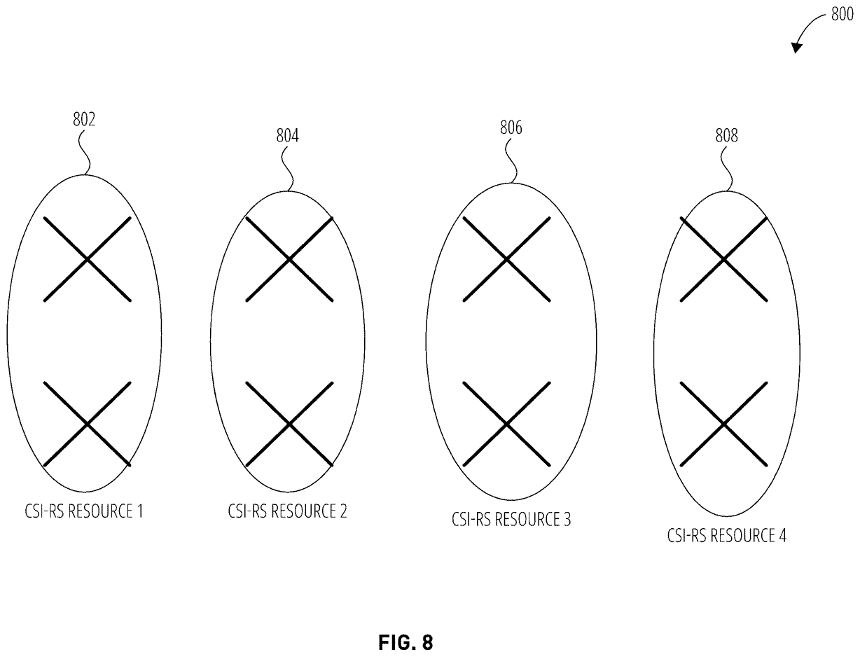

FIG. 8 illustrates an example antenna port configuration 800 that includes a 4-port CSI-RS resources configuration for a 16-port network entity. In FIG. 8, the 4-port CSI-RS resources configuration includes a first CSI-RS Resource 802, a second CSI-RS Resource 804, a third CSI-RS Resource 806, and a fourth CSI-RS Resource 808 defined in the vertical polarity.

In one example, for the CSI-RS configuration in FIG. 8, the network entity configures the CSI-RS multiplexing scheme as horizontal multiplexing for the CSI-RS resources.

FIG. 9 illustrates another example antenna port configuration 900 that includes a 4-port CSI-RS resources configuration for a 16-port network entity. In FIG. 9, the 4-port CSI-RS resources configuration includes a first CSI-RS Resource 902, a second CSI-RS Resource 904, a third CSI-RS Resource 906, and a fourth CSI-RS Resource 908 defined in the horizontal polarity.

In other implementations, the network entity configures the number of CSI-RS resources in horizontal and the number of CSI-RS resources in vertical. Then the UE can identify the location of each CSI-RS resource in the full antenna port grid. In one example, for the CSI-RS configuration in FIG. 8, the network entity configures the number of CSI-RS resources in horizontal as 4 and number of CSI-RS resources in vertical as 1. In another example, for the CSI-RS configuration in FIG. 9, the network entity configures the number of CSI-RS resources in horizontal as 2 and number of CSI-RS resources in vertical as 2.

After reconstructing the codebook, the UE can report the PMI based on the Type1 codebook with the number of antenna ports in horizontal and vertical domain (N1, N2) for the aggregated CSI-RS resources.

### Option 1-2b: PMI Report Based on a Type1 Multi-Panel Codebook Configuration

In some implementations, the network entity configures a Type1 multi-panel codebook for a CSI-RS resource by the first control signaling. In one example, the network entity configures the codebookConfig with the codebookType set as type1-MultiPanel. Then the UE can measure and report the PMI based on the configured Type1 multi-panel codebook based on the estimated channel from the selected CSI-RS resources. The UE determines one CSI-RS resource corresponding to a panel for the multi-panel codebook, ignores the number of panels (Ng) configured in the codebook configuration and determines the number of panels (Ng) as the number of selected CSI-RS resources. Then the UE reports the PMI based on the determined Ng, and (N1, N2) configured in the codebook configuration for the multi-panel codebook.

### Option 1-2c: PMI Report Based on a Type2 Codebook Configuration

In some implementations, the network entity configures a Type2 codebook for a CSI-RS resource by the first control signaling. In one example, the network entity configures the codebookConfig with the codebookType set as type2. Then the UE can measure and report the PMI based on the configured Type2 codebook based on the estimated channel from the selected CSI-RS resources. Then the reported precoder for K reported CSI-RS resources in a subband s can be as follows (formula (5)):

$${W}_{s} = [ \begin{matrix}{W}_{1} {W}_{1 , 2 , s} \\ {W}_{1} {W}_{2 , 2 , s} \\ ⋮ \\ {W}_{1} {W}_{K - 1 , 2 , s} \\ {W}_{1} {W}_{K , 2 , s}\end{matrix} ] \qquad ( 5 )$$

Where W₁ is spatial domain (SD) basis, which is selected from the Type2 codebook configured by the RRC signaling from the network entity with the dimension of Nₚ×2L; L is the number of SD basis configured by the Type2 codebook configuration; w_{k,2,s} is the beam combining matrix for CSI-RS resource k in subband s with the dimension of 2L×Nₗ; Nₚ is the number of antenna ports per CSI-RS resource; Nₗ is the number of layers indicated by the reported RI.

In some implementations, the UE reports the CSI with PMI indicating the W1 and a subset of or all the coefficients in the matrix W_{1,2,1}, W_{2,2,1}, . . . , W_{K,2,1}, . . . , W_{1,2,S,}, W_{2,2,S}, . . . , W_{K,2,S}, where indicates the total number of subbands. In some implementations, the UE only reports M strongest coefficients for each beam combining matrix, where M may be configured by the network entity or reported by the UE. In some other implementations, the UE only reports Q strongest coefficients across the beam combining matrixes, where Q may be configured by the network entity or reported by the UE. In some implementations, the UE reports an indicator that indicates the location of the reported strongest coefficients for the beam combining matrix(es).

Option 1-2d: PMI Report Based on an Enhanced Type 2 (eType2) Codebook Configuration

In some implementations, the network entity configures an enhanced Type2 (eType2) codebook for a CSI-RS resource by the first control signaling. In one example, the network entity configures the codebookConfig with the codebookType set as eType2. Then the UE can measure and report the PMI based on the configured eType2 codebook based on the estimated channel from the selected CSI-RS resources.

In some implementations, the reported precoder for K reported CSI-RS resources can be as follows (formula (6)):

$$W = [ \begin{matrix}{W}_{1} {\tilde{W}}_{1 , 2} {W}_{f} \\ {W}_{1} {\tilde{W}}_{2 , 2} {W}_{f} \\ ⋮ \\ {W}_{1} {\tilde{W}}_{K - 1 , 2} {W}_{f} \\ {W}_{1} {\tilde{W}}_{K , 2} {W}_{f}\end{matrix} ] \qquad ( 6 )$$

Where W₁ is spatial domain (SD) basis, which is selected from the eType2 codebook configured by the RRC signaling from the network entity with the dimension of Nₚ×2L; Lis the number of SD basis configured by the eType2 codebook configuration; \tilde{W}_{k,2} is the beam combining matrix for CSI-RS resource k with the dimension of 2L×Mᵥ; Nₚ is the number of antenna ports per CSI-RS resource; Mᵥ is the number of frequency domain (FD) basis; W_{f} is the FD basis with the dimension of Mᵥ×S, where the number of candidate FD basis and/or number of reported FD basis is configured by the RRC signaling from the network entity or reported by the UE.

In some implementations, the UE reports the CSI with PMI indicating the W1, a subset of or all the coefficients in the matrix \tilde{W}_{1,2}, \tilde{W}_{2,2}, . . . , \tilde{W}_{K,2} and the selected FD basis W_{f}. In some implementations, the UE only reports M strongest coefficients for each beam combining matrix, where M may be configured by the network entity or reported by the UE. In some other implementations, the UE only reports Q strongest coefficients across the beam combining matrixes, where Q may be configured by the network entity or reported by the UE. In some implementations, the UE reports an indicator that indicates the location of the reported strongest coefficients for the beam combining matrix(es).

In some other implementations, the reported precoder for K reported CSI-RS resources can be as follows (formula (7)):

$$W = [ \begin{matrix}{W}_{1} {\tilde{W}}_{1 , 2} {W}_{1 , f} \\ {W}_{1} {\tilde{W}}_{2 , 2} {W}_{2 , f} \\ ⋮ \\ {W}_{1} {\tilde{W}}_{K - 1 , 2} {W}_{K - 1 , f} \\ {W}_{1} {\tilde{W}}_{K , 2} {W}_{K , f}\end{matrix} ] \qquad ( 7 )$$

Where W_{k,f} is the FD basis corresponding to CSI-RS resource k.

In some implementations, the UE reports the CSI with PMI indicating the W1, a subset of or all the coefficients in the matrix \tilde{W}_{1,2}, \tilde{W}_{2,2}, . . . , \tilde{W}_{K,2}, and the selected FD basis W_{1,f}, W_{2,f}, . . . , W_{K,f}.

### Option 1-2e: PMI Report Based on a Set of Codebook Configuration

In some implementations, the network entity configures a set of codebook configurations by the first control signaling. In one example, the network entity configures a set of codebookConfig in CSI-ReportConfig, where each codebook configurations correspond to a CSI-RS resource(s) combination. In another example, the network entity configures a codebookConfig in more than one CSI-ReportConfig, where each codebook configurations correspond to a CSI-RS resource(s) combination in the CSI-ReportConfig. Then the UE reports the PMI based on the configured codebook corresponding to the reported CSI-RS resources combination.

In some implementations, the network entity configures the same type of codebook, such as the same codebookType, for each codebook configurations. In some other implementations, the UE may report the UE capability indicating whether it supports different codebook types for different CSI-RS resource combinations.

Option 2: CSI Report Based on CSI-RS Resources with Different Number of Ports

In some implementations, the network entity configures a list of CSI-RS resources with different number of ports in a CSI report configuration or multiple CSI report configuration, where the network entity configures the CSI-RS resources share the same quasi-co-location properties, including a subset of or all the QCL parameters: {Doppler shift, Doppler spread, average delay, delay spread, Spatial receiving (Rx) parameter, antenna gain}.

Compared to option 1, the key difference is that in option 2, the UE performs a CSI measurement hypothesis based on one CSI-RS resource, and the antenna ports for the CSI-RS resources can be a subset of antenna ports from one CSI-RS resource with the largest number of antenna ports. In some implementations, the network entity may deactivate or activate a CSI-RS resource by MAC CE or DCI.

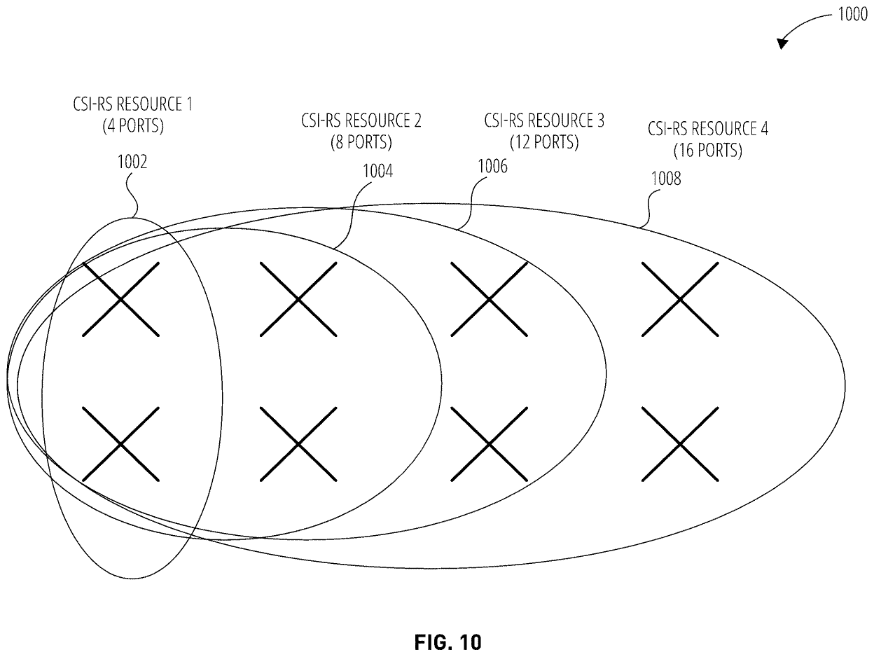

FIG. 10 illustrates an example CSI-RS configuration 1000 with different number of ports. The example CSI-RS configuration 1000 includes a first CSI-RS Resource 1002, a second CSI-RS Resource 1004, a third CSI-RS Resource 1006, and a fourth CSI-RS Resource 1008. The first CSI-RS Resource 1002 includes 4 antennas (4 ports); the second CSI-RS Resource 1004 includes 8 antennas (8 ports); the third CSI-RS Resource 1006 includes 12 antennas (12 ports); and the fourth CSI-RS Resource 1008 includes 16 antennas (16 ports).

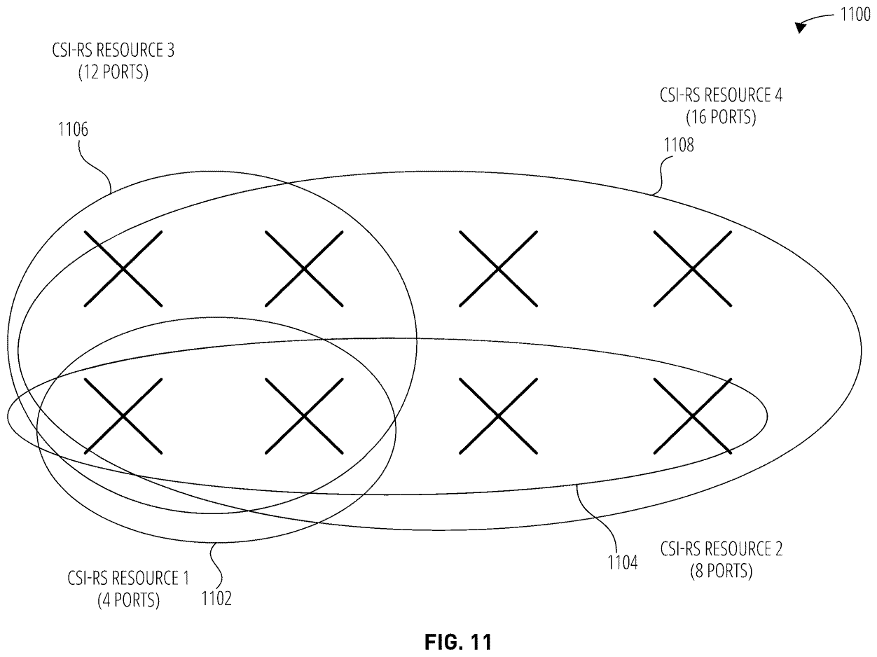

FIG. 11 illustrates another example CSI-RS configuration 1110 with different number of ports. Similar to FIG. 10, the example CSI-RS configuration 1110 includes four combinations of antenna ports: a first CSI-RS Resource 1102 (4 ports using 2 antennas), a second CSI-RS Resource 1104 (8 ports using 4 antennas), a third CSI-RS Resource 1106 (8 ports using 4 antennas different from the 4 antennas in the second CSI-RS Resource 1104), and a fourth CSI-RS Resource 1108 (16 ports using 8 antennas). Note that while the second CSI-RS Resource 1104 and the third CSI-RS Resource 1106 both have the same quantity of ports and antennas, the set of CSI-RS resources associated with the second CSI-RS Resource 1104 and the third CSI-RS Resource 1106 are different.

### Option 2-1a: CSI Report for Single CSI Measurement Hypothesis

In some implementations, the UE reports the CSI based on a single CSI measurement hypothesis, i.e., a single CSI-RS resource. The UE transmits an indicator, such as CRI, indicating the CSI-RS resource for CSI measurement.

In some implementations, the UE determines the reported CSI-RS resource based on the spectrum efficiency and the number of ports for the CSI-RS resource. In one example, the UE selects the CSI-RS resource that can produce the highest spectrum efficiency based on the reported CQI and RI, where the spectrum efficiency indicated by CQI and RI can be calculated as follows (formula (8)):

SE-SE_{CQI}N_{L} (8)
Where SE_{CQI} is the spectrum efficiency indicated by CQI, and N_{L} is the number of layers indicated by RI. For the CSI-RS resource that can produce the same SE, the UE selects the CSI-RS resource with a smaller number of antenna ports.

In some other implementations, the network entity configures a target spectrum efficiency. The UE determines the reported CSI-RS resource based on the target spectrum efficiency and the number of antenna ports for the CSI-RS resource. In one example, the UE selects the CSI-RS resource with the smallest number of antenna ports that can produce the spectrum efficiency higher than the target spectrum efficiency.

### Option 2-1b: CSI Report for Multiple CSI Measurement Hypothesis

In some implementations, the UE reports multiple CSIs, where each CSI corresponds to each configured CSI-RS resource.

In some implementations, the UE reports a common RI and PMI based on the configured CSI-RS resource with the largest number of ports. The network entity can derive the PMI for other CSI-RS resources based on the antenna port configuration for the CSI-RS resource and PMI. In some other implementations, the UE reports separate RI for each CSI and a common full rank PMI based on the CSI-RS resource with the largest number of antenna ports. In some other implementations, the UE reports separate RI and PMI for each CSI-RS resources combination group.

In some implementations, the UE reports absolute CSI for each configured or active CSI-RS resource. In some other implementations, the UE reports absolute CSI for the CSI-RS resource with the largest number of antenna ports, and reports differential CSI for the other CSI-RS resources. In one example, the UE reports a common RI and absolute CQI for the CSI-RS resource with the largest number of antenna ports, and reports differential CQI for the other CSI-RS resources with the absolute CQI as reference.

### Option 2-2a: PMI Report Based on a Codebook Configuration

In some implementations, the network entity configures a single codebook configuration based on one CSI-RS resource. The UE measures CSI for the CSI-RS resource based on the configured codebook, and the UE measures CSI for other CSI-RS resource based on a reconstructed codebook based on the number of ports for the other CSI-RS resource and the configured codebook configuration.

In some implementations, the network entity configures the single codebook configuration based on the CSI-RS resource with the largest configured number of antenna ports. In some implementations, the network entity configures the antenna port index(es) for a CSI-RS resource from the full antenna port configuration configured in the codebook configuration. Then the UE can reconstruct the codebook based on the antenna port index(es) and measure the PMI for the CSI-RS resource based on the reconstructed codebook. In some other implementations, the network entity configures the number of horizontal antenna ports and vertical antenna ports for each CSI-RS resource. Then the UE can reconstruct the codebook based on the configured the number of horizontal antenna ports and vertical antenna ports for the CSI-RS resource and other parameters configured in the codebook configuration, and measures the PMI based on the reconstructed codebook.

### Option 2-2b: PMI Report Based on Multiple Codebook Configurations

In some implementations, the network entity configures a set of codebook configurations by the first control signaling. In one example, the network entity configures a set of codebookConfig in CSI-ReportConfig, where each codebook configurations correspond to each CSI-RS resource. In another example, the network entity configures a codebookConfig in more than one CSI-ReportConfig, where each codebook configurations correspond to each CSI-RS resource in the CSI-ReportConfig. Then the UE reports the PMI based on the configured codebook corresponding to the reported CSI-RS resource.

In some implementations, the network entity configures the same type of codebook, such as the same codebookType, for each codebook configurations. In some other implementations, the UE may report the UE capability indicating whether it supports different codebook types for different CSI-RS resource combinations.

### Option 3: CSI Report Based on a Single CSI-RS Resource

In some implementations, the network entity configures a single CSI-RS resource in a CSI report configuration, and the UE can report CSI based on a subset of antenna ports or all antenna ports from the configured CSI-RS resource.

Compared to option 1 and option 2, the key difference is that in option 3, the UE performs multiple CSI measurement hypothesis based on the configured CSI-RS resource, and the UE measures the CSI measurement hypothesis based on different antenna ports from the configured CSI-RS resource. In some implementations, the network entity may dynamically update the number of antenna ports for a CSI-RS by MAC CE or DCI.

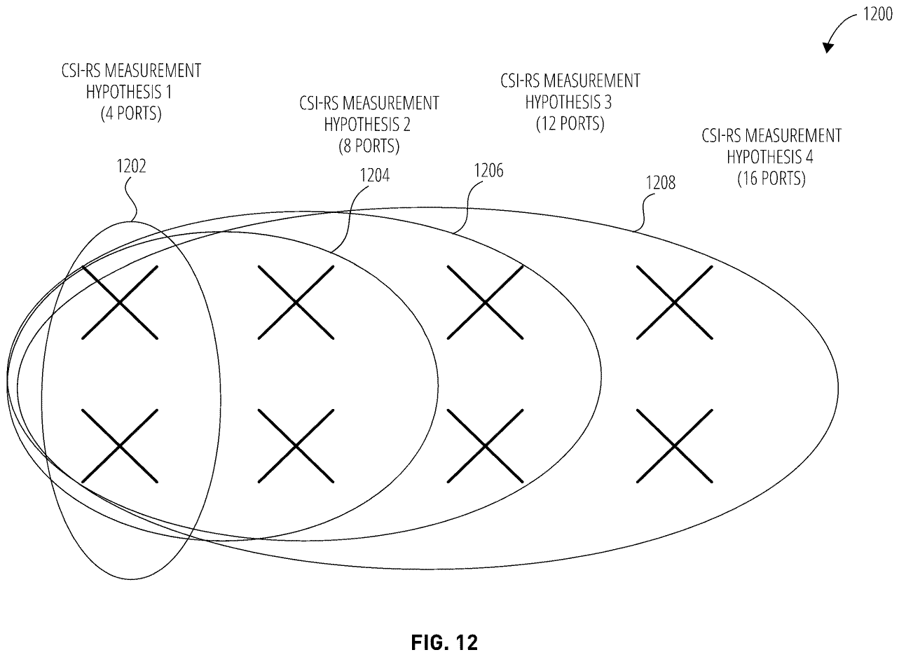

FIG. 12 illustrates an example set of CSI measurement hypotheses in which the CSI measurement hypotheses are based on different antenna ports from a CSI-RS resource. A first CSI-RS measurement hypothesis 1202 includes 4 antennas (4 ports); a second CSI-RS measurement hypothesis 1204 includes 8 antennas (8 ports); a third CSI-RS measurement hypothesis 1206 includes 12 antennas (12 ports); and a fourth CSI-RS measurement hypothesis 1208 includes 16 antennas (16 ports).

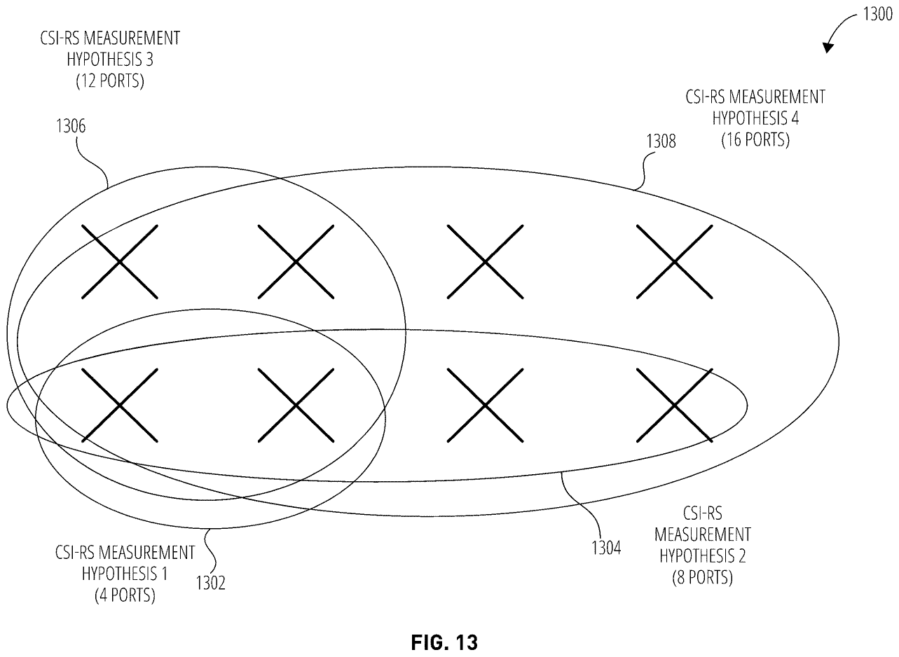

FIG. 13 illustrates another example set of CSI measurement hypotheses in which the CSI measurement hypotheses are based on different antenna ports from a CSI-RS resource. A first CSI-RS measurement hypothesis 1302 includes 4 antennas (4 ports); a second CSI-RS measurement hypothesis 1304 includes 8 antennas (8 ports); a third CSI-RS measurement hypothesis 1306 includes 8 antennas (8 ports); and a fourth CSI-RS measurement hypothesis 1308 includes 16 antennas (16 ports). A comparison between FIG. 12 and FIG. 13 shows that the CSI-RS measurement hypotheses can be different and include different quantities and selections of antenna ports.

### Option 3-1a: CSI Report for Single CSI Measurement Hypothesis

In some implementations, the UE reports the CSI based on a single CSI measurement hypothesis, i.e., CSI measured from a subset of or all the antenna port(s) for the configured CSI-RS resource. The UE reports the CSI with an antenna port(s) indicator (API) indicating the measured antenna port(s).

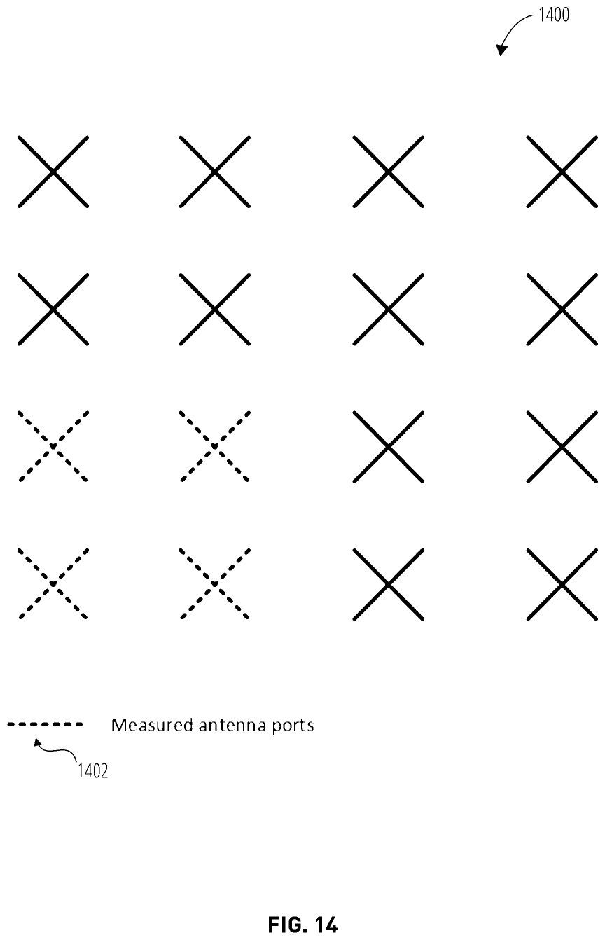

FIG. 14 illustrates an example CSI measurement in which the UE measures a subset of the antenna ports for a CSI-RS resource. In some implementations, the UE reports the API indicating the number of consecutive horizontal antenna ports N1 and number of consecutive vertical antenna ports N2. The UE measures the CSI based on the N1 by N2 antenna ports. FIG. 14 illustrates one example for the measured antenna ports 1402 when the reported API indicating N1=2 and N2=2. The measured antenna ports 1402 are indicated by dashed lines and include a combination of two consecutive vertical antenna ports and two consecutive horizontal antenna ports.

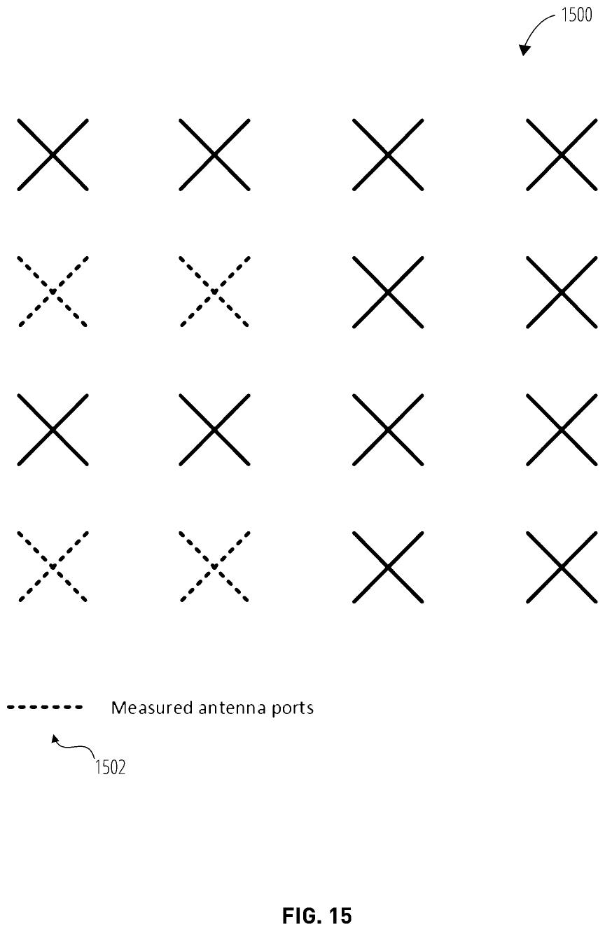

FIG. 15 illustrates another example CSI measurement in which the UE measures a subset of the antenna ports for a CSI-RS resource. In some implementations, the UE reports the API indicating the number of horizontal antenna ports N1, number of vertical antenna ports N2, the horizontal antenna ports spacing S1 and the vertical antenna ports spacing S2. FIG. 15 illustrates one example for the measured antenna ports 1502 when the reported API indicating (N1, N2, S1, S2)=(2, 2, 1, 2). The measured antenna ports 1502 are indicated by dashed lines and include a combination of four antenna ports when the reported API indicating (N1, N2, S1, S2)=(2, 2, 1, 2).

In some implementations, the UE reports the measured antenna port index(es) in the CSI report, and the UE measures the CSI from the reported antenna port index(es).

In some implementations, the network entity configures the candidate measured antenna ports group(s) for the CSI report. Alternatively, the candidate measured antenna ports group(s) for an antenna structure configured in the codebook configuration could be predefined. The UE reports the API indicating one of the configured measured antenna ports groups.

In some implementations, the UE determines the reported the API based on the spectrum efficiency and the number of ports indicated by the API. In one example, the UE selects the antenna ports that can produce the highest spectrum efficiency based on the reported CQI and RI, where the spectrum efficiency indicated by CQI and RI can be calculated as follows (formula (9)):

SE=SE_{CQI}N_{L} (9)
Where SE_{CQI} is the spectrum efficiency indicated by CQI, and N_{L} is the number of layers indicated by RI. For the CSI-RS resource that can produce the same SE, the UE selects the CSI-RS resource with a smaller number of antenna ports.

In some other implementations, the network entity configures a target spectrum efficiency. The UE determines the API based on the target spectrum efficiency. In one example, the UE selects the smallest number of antenna ports that can produce the spectrum efficiency higher than the target spectrum efficiency.

### Option 3-1b: CSI Report for Multiple CSI Measurement Hypothesis

In some implementations, the UE reports multiple CSIs, where each CSI corresponds to an antenna port configuration. In some implementations, the network entity configures the candidate measured antenna ports group(s) for the CSI report. Alternatively, the candidate measured antenna ports group(s) for an antenna structure configured in the codebook configuration could be predefined. The UE reports the CSIs for all the candidate measured antenna ports group(s).

In some implementations, the UE reports a common RI and PMI based on the antenna ports group with the largest number of antenna ports. The network entity can derive the PMI for smaller number of antenna ports group based on the antenna ports index and the reported PMI. In some other implementations, the UE reports separate RI for each CSI and a common full rank PMI based on the antenna ports group with the largest number of antenna ports. In some other implementations, the UE reports separate RI and PMI for each antenna ports group.

In some implementations, the UE reports absolute CSI for each antenna ports group. In some other implementations, the UE reports absolute CSI for the antenna ports group with the largest number of antenna ports, and reports differential CSI for the other antenna ports group. In one example, the UE reports a common RI and absolute CQI for the antenna ports group with the largest number of antenna ports, and reports differential CQI for the other antenna ports group with the absolute CQI as reference.

### Option 3-2a: PMI Report Based on a Codebook Configuration

In some implementations, the network entity configures a single codebook configuration based on one antenna ports group. The UE measures CSI corresponding to an API based on the antenna ports indicated by the API and other parameters in the codebook configuration.

Option 3-2b: PMI report based on multiple codebook configurations

In some implementations, the network entity configures a set of codebook configurations by the first control signaling. In one example, the network entity configures a set of codebookConfig in CSI-ReportConfig, where each codebook configurations correspond to a candidate antenna ports group. In another example, the network entity configures a codebookConfig in more than one CSI-ReportConfig, where each codebook configurations correspond to each CSI-RS resource in the CSI-ReportConfig. Then the UE reports the PMI based on the configured codebook corresponding to the reported CSI-RS resource.

In some implementations, the network entity configures the same type of codebook, such as the same codebookType, for each codebook configurations. In some other implementations, the UE may report the UE capability indicating whether it supports different codebook types for different CSI-RS resource combinations.

FIGS. 1 to 15 and the operations described herein are examples meant to aid in understanding example implementations and should not be used to limit the potential implementations or limit the scope of the claims. Some implementations might include additional operations, fewer operations, operations in parallel or in a different order, and some operations differently.

The foregoing disclosure provides illustration and description but is not intended to be exhaustive or to limit the aspects to the precise form disclosed. Modifications and variations may be made in light of the above disclosure or may be acquired from practice of the aspects. While the aspects of the disclosure have been described in terms of various examples, any combination of aspects from any of the examples is also within the scope of the disclosure. The examples in this disclosure are provided for pedagogical purposes. Alternatively, or in addition to the other examples described herein, examples include any combination of the following implementation options (enumerated as clauses for clarity).

### CLAUSES

Clause 1. A method for wireless communication at a User Equipment (UE), including: receiving, via control signaling from a network entity, one or more channel state information (CSI) report configurations that indicate at least one CSI reference signal (CSI-RS) resource and that configures one or more CSI reports to include port adaptation information; receiving the at least one CSI-RS resource; and transmitting the one or more CSI reports with the port adaptation information based on measurements of the at least one CSI-RS resource, where the port adaptation information indicates at least one antenna port configuration and a respective CSI for the at least one antenna port configuration.

Clause 2. The method of clause 1, further including: transmitting a UE capability message to the network entity, where the UE capability message indicates one or more of the following elements: an indication that the UE supports generation of the port adaptation information, a maximum number of configured CSI-RS resources that the UE can support for port adaptation, a maximum number of CSI-RS resources in a slot that the UE can support for port adaptation, a list of supported antenna port configurations for CSI reporting, an indication of supported codebook type or types, or a maximum quantity of supported codebook configurations.

Clause 3. The method of clause 1, where the control signaling indicates a plurality of CSI-RS resources, the method further including: measuring the plurality of CSI-RS resources using a plurality of candidate antenna port configurations; and transmitting a first CSI report of the one or more CSI reports, where the first CSI report includes a first CSI for a first antenna port configuration of the plurality of candidate antenna port configurations, and where the first CSI report further includes port adaptation information indicating the first antenna port configuration.

Clause 4. The method of clause 2, further including: receiving, via the control signaling, a list indicating the plurality of candidate antenna port configurations.

Clause 5. The method of any one of clauses 2-4, further including: selecting the first antenna port configuration from among the plurality of antenna port configurations based on CSI measurements corresponding to the plurality of antenna port configurations, where the first antenna port configuration satisfies a target spectrum efficiency with a lowest number of a total antenna ports from among the plurality of antenna port configurations.

Clause 6. The method of any one of clauses 3-5, further including: transmitting at least a second CSI report of the one or more CSI reports, where the second CSI report indicates a second antenna port configuration of the plurality of antenna port configurations and includes a second CSI for the second antenna port configuration.

Clause 7. The method of clause 1, where the CSI report configuration indicates a single CSI-RS resource, the method further including: measuring the single CSI-RS resource using more than one antenna port; and transmitting at least a first CSI report of the one or more CSI reports, where the first CSI report includes a first CSI for a first set of antenna ports, and where the first CSI report includes an antenna port indicator (API) indicating the first set of antenna ports.

Clause 8. The method of clause 7, where the first CSI report includes port adaptation information that indicates a list of the measured antenna ports.

Clause 9. The method of any one of clauses 7-8, where the first CSI report includes an antenna port configuration indicating: a number of consecutive horizontal antenna ports and a number of consecutive vertical antenna ports; or a number of horizontal antenna ports, a number of vertical antenna ports, horizontal antenna ports spacing, and vertical antenna ports spacing.

Clause 10. The method of any one of clauses 1-8, where the one or more CSI reports include a plurality of CSI corresponding to a plurality of antenna port configurations, and where the one or more CSI reports include information indicative of rank indicator (RI), precoding matrix indicator (PMI) and channel quality indicator (CQI).

Clause 11. The method of clause 10, further including: transmitting the plurality of CSI in separate CSI reports, each CSI report indicating the CSI for a particular antenna port configuration.

Clause 12. The method of clause 10, further including: transmitting the plurality of CSI in a common CSI report that includes CSI for each of the plurality of antenna port configurations.

Clause 13. The method of any one of clauses 10-12, where the information indicative of RI, PMI, and CQI includes: separate RI, PMI and CQI values for each antenna port configuration of the plurality of antenna port configurations; a common RI and PMI value based on a first antenna port configuration with a largest number of ports and separate CQI for each antenna port configuration of the plurality of antenna port configurations; an absolute CQI for the first antenna port configuration and differential CQI for each of the other antenna port configurations using the absolute CQI as reference; or a common full rank PMI based on the first antenna port configuration and separate RI and CQI for each antenna port configuration of the plurality of antenna port configurations.

Clause 14. The method of clause 12, further including: receiving, via the control signaling, information configuring a same number of antenna ports in different antenna port configurations for the at least one CSI-RS resource.

Clause 15. The method of clause 14, further including: transmitting an indicator indicating one or more CSI-RS resource indicators (CRIs) and other CSI measured from a subset of the at least one CSI-RS resource indicated by the one or more CRIs.

Clause 16. The method of clause 13, further including: receiving, via the control signaling, information configuring one or more CSI-RS resource groups for CSI measurement; and transmitting at least a first CSI measured from at least a first CSI-RS resource group of the one or more CSI-RS resource groups and an indicator indicating a first CSI-RS resource group index identifying the first CSI-RS resource group.

Clause 17. The method of clause 16, further including transmitting multiple CSIs, where each CSI of the multiple CSIs corresponds to a particular CSI-RS resource group of the one or more CSI-RS resource groups.

Clause 18. The method of any one of clauses 1-16, further including: receiving, via the control signaling, information configuring at least one codebook based on a number of ports configured for the at least one CSI-RS resource.

Clause 19. The method of clause 18, further including: transmitting a PMI for a CSI-RS resource group based on an antenna ports configuration in the at least one codebook and at least one indicator indicating the antenna combining factor across the CSI-RS resources in the at least one CSI-RS resource group.

Clause 20. The method of clause 18, further including: transmitting a PMI for a CSI-RS resource group based on each of a plurality of antenna ports configuration for the at least one CSI-RS resource.

Clause 21. The method of any one of clauses 18-20, where the at least one codebook includes: a Type1 single-panel codebook, a Type1 multi-panel codebook, a Type2 codebook, an eType2 codebook, or a set of codebooks.

Clause 22. The method of any one of clauses 18-21, further including: transmitting a PMI for a CSI-RS resource group indicating common spatial domain basis and separate beam combining matrix for each subband for each CSI-RS resources in the CSI-RS resource group; transmitting the PMI for the CSI-RS resource group indicating common spatial domain basis, common frequency domain basis, and separate beam combining matrix for each CSI-RS resources in the CSI-RS resource group; transmitting the PMI for the CSI-RS resource group indicating common spatial domain basis, separate frequency domain basis, and separate beam combining matrix for each CSI-RS resources in the CSI-RS resource group; or transmitting the PMI for the CSI-RS resource group based on a first codebook configuration of a set of codebooks, the first codebook configuration corresponding to the CSI-RS resource group.

Clause 23. A method for wireless communication at a network entity, the method including: transmitting, via first control signaling to a user equipment (UE), one or more channel state information (CSI) report configurations that indicate at least one CSI reference signal (CSI-RS) resource and that configures one or more CSI reports to include port adaptation information; transmitting the at least one CSI-RS resource; receiving the one or more CSI reports with the port adaptation information, where the port adaptation information indicates at least one antenna port configuration and a respective CSI for the at least one antenna port configuration.

Clause 24. The method of clause 23, further including: configuring a first antenna port configuration for subsequent Multiple-Input-Multiple-Output (MIMO) transmissions to the UE based, at least in part, on the port adaptation information.

Clause 25. An apparatus, including: a communication unit; and a processing system configured to control the communication unit to implement the methods of any one of clauses 1 to 24.

Clause 26. An apparatus, including a processer configured to cause a User Equipment (UE) to: receive a control signaling configuring at least one CSI reference signal (CSI-RS) resource for CSI feedback for port adaptation, at least one CSI measurement from fewer or more antenna ports than the configured antenna ports for the CSI-RS, and at least one codebook for CSI feedback for port adaptation; receive the configured at least one CSI-RS resource; and transmit a CSI report based on the received at least one CSI-RS resource including at least a CSI measured from fewer or more antenna ports than the configured antenna ports for the at least one CSI-RS resource.

Clause 27. The apparatus according to clause 26, where UE transmits the UE capability indicating at least one of the elements: whether the UE supports CSI report for port adaptation; the maximum number of configured CSI-RS resources for CSI report for port adaptation; the maximum number of CSI-RS resources in a slot for CSI report for port adaptation; the supported antenna ports structures; the supported codebook type for the CSI report for port adaptation.

Clause 28. The apparatus according to clause 26, where the UE transmits an indicator indicating the measured antenna port(s).

Clause 29. The apparatus according to clause 28, where the UE transmits the indicator indicating the number of consecutive horizontal antenna ports and number of consecutive vertical antenna ports for the reported CSI.

Clause 30. The apparatus according to clause 28, where the UE transmits the indicator indicating the number of horizontal antenna ports, number of vertical antenna ports, the horizontal antenna ports spacing and the vertical antenna ports spacing.

Clause 31. The apparatus according to clause 26, where the UE receives a control signaling configuring the candidate antenna ports groups for CSI measurement.

Clause 32. The apparatus according to clause 28 and clause 31, where the UE transmits the indicator indicating one of the configured antenna ports groups for the reported CSI.

Clause 33. The apparatus according to clause 31, where the UE transmits more than one CSIs, where each CSI corresponds to each configured antenna ports group.

Clause 34. The apparatus according to clause 33, where the UE transmits separate rank indicator (RI), precoder matrix indicator (PMI) and channel quality indicator (CQI) for each configured antenna ports group.

Clause 35. The apparatus according to clause 33, where the UE transmits a common RI and PMI based on the antenna ports group with largest number of ports, and separate CQI for each antenna ports group.

Clause 36. The apparatus according to clause 35, where the UE transmits absolute CQI for the antenna ports group with largest number of ports and differential CQI for the other antenna ports group with the absolute CQI as reference.

Clause 37. The apparatus according to clause 33, where the UE transmits a common full rank PMI based on the antenna ports group with largest number of ports and separate RI and CQI for each antenna ports group.

Clause 38. The apparatus according to clause 26, where the UE receives the control signaling configuring more than one CSI-RS resource.

Clause 39. The apparatus according to clause 38, where the UE receives the control signaling configuring the same number of antenna ports for the CSI-RS resources.

Clause 40. The apparatus according to clause 39, where the UE transmits an indicator indicating one or more than one CSI-RS resource indicator (CRI) and other CSI measured from the CSI-RS resources indicated by the CRI(s).

Clause 41. The apparatus according to clause 39, where the UE receives a control signaling configuring the CSI-RS resource group(s) for CSI measurement.

Clause 42. The apparatus according to clause 41, where the UE transmits a CSI measured from one of the CSI-RS resource groups and an indicator indicating the CSI-RS resource group index.

Clause 43. The apparatus according to clause 41, where the UE transmits multiple CSIs, where each CSI is measured from each CSI-RS resource group.

Clause 44. The apparatus according to clause 40 to clause 43, where the UE receives a control signaling configuring a Type1 single-panel codebook based on the number of ports configured for one of the configured CSI-RS resources.

Clause 45. The apparatus according to clause 44, where the UE transmits a PMI for a CSI-RS resource group based on the antenna ports configuration in the codebook and at least one indicator indicating the antenna combining factor across the CSI-RS resources in the CSI-RS resource group.

Clause 46. The apparatus according to clause 44, where the UE transmits a PMI for a CSI-RS resource group based on the antenna ports configuration for the CSI-RS resources in the CSI-RS resource group.

Clause 47. The apparatus according to clause 40 to clause 43, where the UE receives a control signaling configuring a Type1 multi-panel codebook based on the number of ports configured for one of the configured CSI-RS resources.

Clause 48. The apparatus according to clause 47, where the UE transmits a PMI for a CSI-RS resource group based on the antenna ports configuration in the codebook and the number of CSI-RS resources in the CSI-RS resource group.

Clause 49. The apparatus according to clause 40 to clause 43, where the UE receives a control signaling configuring a Type2 codebook based on the number of ports configured for one of the configured CSI-RS resources.

Clause 50. The apparatus according to clause 49, where the UE transmits a PMI for a CSI-RS resource group indicating common spatial domain basis and separate beam combining matrix for each subband for each CSI-RS resources in the CSI-RS resource group.

Clause 51. The apparatus according to clause 40 to clause 43, where the UE receives a control signaling configuring an eType2 codebook based on the number of ports configured for one of the configured CSI-RS resources.

Clause 52. The apparatus according to clause 49, where the UE transmits a PMI for a CSI-RS resource group indicating common spatial domain basis, common frequency domain basis, and separate beam combining matrix for each CSI-RS resource in the CSI-RS resource group.

Clause 53. The apparatus according to clause 49, where the UE transmits a PMI for a CSI-RS resource group indicating common spatial domain basis, separate frequency domain basis, and separate beam combining matrix for each CSI-RS resources in the CSI-RS resource group.

Clause 54. The apparatus according to clause 40 to clause 43, where the UE receives a control signaling configuring a set of codebook configurations, where each codebook corresponds to each CSI-RS resource group.

Clause 55. The apparatus according to clause 54, where the UE transmits a PMI for a CSI-RS resource group based on the codebook configuration corresponding to the CSI-RS resource group.

Clause 56. The apparatus according to clause 38, where the UE receives the control signaling configuring the different number of antenna ports for the CSI-RS resources.

Clause 57. The apparatus according to clause 56, where the UE transmits an indicator indicating one of the configured CSI-RS resources and CSI measured from the indicated CSI-RS resource.

Clause 58. The apparatus according to clause 56, where the UE transmits multiple CSIs, where each CSI corresponds to a CSI-RS resource.

Clause 59. The apparatus according to clause 56, where the UE receives a control signaling configuring a codebook configuration.

Clause 60. The apparatus according to clause 59, where the UE transmits the PMI for a CSI-RS resource based on the antenna ports configuration for the CSI-RS and the configured codebook.

Clause 61. The apparatus according to clause 56, where the UE receives a control signaling configuring a set of codebook configurations, where each codebook corresponds to each configured CSI-RS resource.

Clause 62. The apparatus according to clause 61, where the UE transmits a PMI for a CSI-RS resource based on the codebook configuration corresponding to the CSI-RS resource.

Clause 63. An apparatus, including a processer configured to cause a network entity to: transmit a control signaling configuring at least one CSI reference signal (CSI-RS) resource for CSI feedback for port adaptation, at least one CSI measurement from fewer or more antenna ports than the configured antenna ports for the CSI-RS, and at least one codebook for CSI feedback for port adaptation; transmit the configured at least one CSI-RS resource; receive a CSI report including at least a CSI measured from fewer or more antenna ports than the configured antenna ports for the at least one CSI-RS resource.

Clause 64. The apparatus according to clause 63, where BS receives the UE capability indicating at least one of the elements: whether the UE supports CSI report for port adaptation; the maximum number of configured CSI-RS resources for CSI report for port adaptation; the maximum number of CSI-RS resources in a slot for CSI report for port adaptation; the supported antenna ports structures; the supported codebook type for the CSI report for port adaptation.

Clause 65. The apparatus according to clause 63, where the BS receives an indicator indicating the measured antenna port(s).

Clause 66. The apparatus according to clause 65, where the BS receives the indicator indicating the number of consecutive horizontal antenna ports and number of consecutive vertical antenna ports for the reported CSI.

Clause 67. The apparatus according to clause 65, where the BS receives the indicator indicating the number of horizontal antenna ports, number of vertical antenna ports, the horizontal antenna ports spacing and the vertical antenna ports spacing.

Clause 68. The apparatus according to clause 63, where the BS transmits a control signaling configuring the candidate antenna ports groups for CSI measurement.

Clause 69. The apparatus according to clause 65 and clause 68, where the BS receives the indicator indicating one of the configured antenna ports groups for the reported CSI.

Clause 70. The apparatus according to clause 68, where the BS receives more than one CSIs, where each CSI corresponds to each configured antenna ports group.

Clause 71. The apparatus according to clause 70, where the BS receives separate rank indicator (RI), precoder matrix indicator (PMI) and channel quality indicator (CQI) for each configured antenna ports group.

Clause 72. The apparatus according to clause 70, where the BS receives a common RI and PMI based on the antenna ports group with largest number of ports, and separate CQI for each antenna ports group.

Clause 73. The apparatus according to clause 72, where the BS receives absolute CQI for the antenna ports group with largest number of ports and differential CQI for the other antenna ports group with the absolute CQI as reference.

Clause 74. The apparatus according to clause 70, where the BS receives a common full rank PMI based on the antenna ports group with largest number of ports and separate RI and CQI for each antenna ports group.

Clause 75. The apparatus according to clause 63, where the BS transmits the control signaling configuring more than one CSI-RS resources.

Clause 76. The apparatus according to clause 75, where the BS transmits the control signaling configuring the same number of antenna ports for the CSI-RS resources.

Clause 77. The apparatus according to clause 76, where the BS receives an indicator indicating one or more than one CSI-RS resource indicator (CRI) and other CSI measured from the CSI-RS resources indicated by the CRI(s).

Clause 78. The apparatus according to clause 76, where the BS transmits a control signaling configuring the CSI-RS resource group(s) for CSI measurement.

Clause 79. The apparatus according to clause 78, where the UE transmits a CSI measured from one of the CSI-RS resource groups and an indicator indicating the CSI-RS resource group index.

Clause 80. The apparatus according to clause 78, where the BS receives multiple CSIs, where each CSI is measured from each CSI-RS resource groups.

Clause 81. The apparatus according to clause 77 to clause 80, where the BS transmits a control signaling configuring a Type1 single-panel codebook based on the number of ports configured for one of the configured CSI-RS resources.

Clause 82. The apparatus according to clause 81, where the BS receives a PMI for a CSI-RS resource group based on the antenna ports configuration in the codebook and at least one indicator indicating the antenna combining factor across the CSI-RS resources in the CSI-RS resource group.

Clause 83. The apparatus according to clause 81, where the BS receives a PMI for a CSI-RS resource group based on the antenna ports configuration for the CSI-RS resources in the CSI-RS resource group.

Clause 84. The apparatus according to clause 77 to clause 80, where the BS transmits a control signaling configuring a Type1 multi-panel codebook based on the number of ports configured for one of the configured CSI-RS resources.

Clause 85. The apparatus according to clause 84, where the BS receives a PMI for a CSI-RS resource group based on the antenna ports configuration in the codebook and the number of CSI-RS resources in the CSI-RS resource group.

Clause 86. The apparatus according to clause 77 to clause 80, where the BS transmits a control signaling configuring a Type2 codebook based on the number of ports configured for one of the configured CSI-RS resources.

Clause 87. The apparatus according to clause 86, where the BS receives a PMI for a CSI-RS resource group indicating common spatial domain basis and separate beam combining matrix for each subband for each CSI-RS resources in the CSI-RS resource group.

Clause 88. The apparatus according to clause 77 to clause 80, where the BS transmits a control signaling configuring an eType2 codebook based on the number of ports configured for one of the configured CSI-RS resources.

Clause 89. The apparatus according to clause 86, where the BS receives a PMI for a CSI-RS resource group indicating common spatial domain basis, common frequency domain basis, and separate beam combining matrix for each CSI-RS resources in the CSI-RS resource group.

Clause 90. The apparatus according to clause 86, where the BS receives a PMI for a CSI-RS resource group indicating common spatial domain basis, separate frequency domain basis, and separate beam combining matrix for each CSI-RS resources in the CSI-RS resource group.

Clause 91. The apparatus according to clause 77 to clause 80, where the BS transmits a control signaling configuring a set of codebook configurations, where each codebook corresponds to each CSI-RS resource group.

Clause 92. The apparatus according to clause 91, where the BS receives a PMI for a CSI-RS resource group based on the codebook configuration corresponding to the CSI-RS resource group.

Clause 93. The apparatus according to clause 75, where the BS transmits the control signaling configuring the different number of antenna ports for the CSI-RS resources.

Clause 94. The apparatus according to clause 93, where the BS receives an indicator indicating one of the configured CSI-RS resources and CSI measured from the indicated CSI-RS resource.

Clause 95. The apparatus according to clause 93, where the BS receives multiple CSIs, where each CSI corresponds to a CSI-RS resource.

Clause 96. The apparatus according to clause 93, where the BS transmits a control signaling configuring a codebook configuration.

Clause 97. The apparatus according to clause 96, where the BS receives the PMI for a CSI-RS resource based on the antenna ports configuration for the CSI-RS and the configured codebook.

Clause 98. The apparatus according to clause 93, where the BS transmits a control signaling configuring a set of codebook configurations, where each codebook corresponds to each configured CSI-RS resource.

Clause 99. The apparatus according to clause 98, where the BS receives a PMI for a CSI-RS resource based on the codebook configuration corresponding to the CSI-RS resource.

Another innovative aspect of the subject matter described in this disclosure can be implemented as a wireless communication device of a UE or a network entity. The wireless communication device may include at least one interface and a processing system communicatively coupled with the at least one interface. The processing system may be configured to implement any one of the above clauses.

Another innovative aspect of the subject matter described in this disclosure can be implemented as a portable electronic device comprising a wireless communication device, a plurality of antennas coupled to the at least one transceiver to wirelessly transmit signals output from the at least one transceiver and a housing that encompasses the wireless communication device, the at least one transceiver and at least a portion of the plurality of antennas. The wireless communication device may include at least one interface and a processing system communicatively coupled with the at least one interface. The processing system may be configured to implement any one of the above clauses.

Another innovative aspect of the subject matter described in this disclosure can be implemented as a machine-readable medium having processor-readable instructions stored therein that, when executed by a processing system of a UE, cause the UE to implement any one of the above clauses.

Another innovative aspect of the subject matter described in this disclosure can be implemented as an apparatus. The apparatus may include means for implementing any one of the above clauses.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.”

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, or the like.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

In this disclosure, the term “can” indicates a capability, or alternatively indicates a possible implementation option. The term “may” indicates a permission or a possible implementation option.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, for example, a combination of a DSP and a microprocessor, multiple microprocessors, one or more microprocessors in conjunction with a DSP core, or any other such configuration. In some implementations, particular processes, operations and methods may be performed by circuitry that is specific to a given function.

As described above, in some aspects implementations of the subject matter described in this specification can be implemented as software. For example, various functions of components disclosed herein, or various blocks or steps of a method, operation, process or algorithm disclosed herein can be implemented as one or more modules of one or more computer programs. Such computer programs can include non-transitory processor- or computer-executable instructions encoded on one or more tangible processor- or computer-readable storage media for execution by, or to control the operation of, data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

As used herein, the terms “user equipment”, “wireless communication device”, “mobile communication device”, “communication device”, or “mobile device” refer to any one or all of cellular telephones, smartphones, portable computing devices, personal or mobile multi-media players, laptop computers, tablet computers, smartbooks, Internet-of-Things (IoT) devices, palm-top computers, wireless electronic mail receivers, multimedia Internet enabled cellular telephones, wireless gaming controllers, display sub-systems, driver assistance systems, vehicle controllers, vehicle system controllers, vehicle communication system, infotainment systems, vehicle telematics systems or subsystems, vehicle display systems or subsystems, vehicle data controllers or routers, and similar electronic devices which include a programmable processor and memory and circuitry configured to perform operations as described herein.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. A method for wireless communication at a user equipment (UE), comprising:
receiving, via control signaling from a network entity, one or more channel state information (CSI) report configurations that indicate a plurality of CSI reference signal (CSI-RS) resources and that configures one or more CSI reports to include port adaptation information, the one or more CSI report configurations including at least one of:
first information configuring a first plurality of codebooks, each of the first plurality of codebooks having a same codebook type, or
second information configuring a second plurality of codebooks having different codebook types;
receiving the plurality of CSI-RS resources;
measuring the plurality of CSI-RS resources using a plurality of candidate antenna port configurations; and
transmitting the one or more CSI reports with the port adaptation information based on measurements of the plurality of CSI-RS resources, wherein the port adaptation information indicates at least one antenna port configuration and a respective CSI for the at least one antenna port configuration,
wherein the transmitting the one or more CSI reports includes transmitting a first CSI report of the one or more CSI reports, wherein the first CSI report includes a first CSI for a first antenna port configuration of the plurality of candidate antenna port configurations, and wherein the first CSI report further includes port adaptation information indicating the first antenna port configuration.

2. The method of claim 1, further comprising:
transmitting a UE capability message to the network entity, wherein the UE capability message indicates one or more of the following:
an indication that the UE supports generation of the port adaptation information,
a maximum number of configured CSI-RS resources that the UE can support for port adaptation,
a maximum number of CSI-RS resources in a slot that the UE can support for port adaptation,
a list of supported antenna port configurations for CSI reporting,
an indication of supported codebook type or types,
an indication of whether the UE supports different codebook types for different CSI-RS resource combinations, or
a maximum quantity of supported codebook configurations.

3. The method of claim 1, further comprising at least one of:
receiving, via the control signaling, a list indicating the plurality of candidate antenna port configurations;
receiving, via the control signaling, third information configuring a list of one or more CSI-RS resources of the plurality of CSI resources in a CSI report configuration, each of the CSI-RS resources in the list of CSI-RS resources corresponding to a different number of antenna ports; or
receiving, via the control signaling, fourth information configuring a same number of antenna ports in different antenna port configurations for the plurality of CSI-RS resources.

4. The method of claim 1, further comprising:
selecting the first antenna port configuration from among the plurality of candidate antenna port configurations based on CSI measurements corresponding to the plurality of candidate antenna port configurations, wherein the first antenna port configuration satisfies a target spectrum efficiency with a lowest number of a total antenna ports from among the plurality of candidate antenna port configurations.

5. The method of claim 1, further comprising:
transmitting at least a second CSI report of the one or more CSI reports, wherein the second CSI report indicates a second antenna port configuration of the plurality of candidate antenna port configurations and includes a second CSI for the second antenna port configuration.

6. The method of claim 1, wherein the first CSI report includes an antenna port configuration indicating at least one of:
a number of consecutive horizontal antenna ports and a number of consecutive vertical antenna ports; or
a number of horizontal antenna ports, a number of vertical antenna ports, horizontal antenna ports spacing, and vertical antenna ports spacing.

7. The method of claim 1, wherein the one or more CSI reports include a plurality of CSI corresponding to a plurality of antenna port configurations, and wherein the one or more CSI reports include information indicative of rank indicator (RI), precoding matrix indicator (PMI) and channel quality indicator (CQI).

8. The method of claim 7, further comprising at least one of:
transmitting the plurality of CSI in separate CSI reports, each CSI report indicating, for a particular antenna port configuration, a CSI of the plurality of CSI; or
transmitting the plurality of CSI in a common CSI report that includes CSI for each of the plurality of antenna port configurations.

9. (canceled)

10. (canceled)

11. The method of claim 7, wherein the information indicative of RI, PMI, and CQI includes at least one of:
separate RI, PMI and CQI values for each antenna port configuration of the plurality of antenna port configurations;
a common RI and PMI value based on a third antenna port configuration with a largest number of ports and separate CQI for each antenna port configuration of the plurality of antenna port configurations;
an absolute CQI for a fourth antenna port configuration and differential CQI for each of one or more other antenna port configurations using the absolute CQI as reference; or
a common full rank PMI based on a fifth antenna port configuration and separate RI and CQI for each antenna port configuration of the plurality of antenna port configurations.

12. (canceled)

13. The method of claim 3, further comprising:
transmitting an indicator indicating one or more CSI-RS resource indicators (CRIs) and other CSI measured from a subset of the plurality of CSI-RS resources indicated by the one or more CRIs.

14. The method of claim 11, further comprising:
receiving, via the control signaling, information configuring one or more CSI-RS resource groups for CSI measurement; and
transmitting at least a first CSI measured from at least a first CSI-RS resource group of the one or more CSI-RS resource groups and an indicator indicating a first CSI-RS resource group index identifying the first CSI-RS resource group.

15. The method of claim 14, further comprising
transmitting multiple CSIs, where each CSI of the multiple CSIs corresponds to a particular CSI-RS resource group of the one or more CSI-RS resource groups.

16. The method of claim 1, further comprising:
receiving, via the control signaling, information configuring at least one codebook based on a number of ports configured for the plurality of CSI-RS resources.

17. The method of claim 16, further comprising:
receiving, via the control signaling, information configuring one or more antenna port indexes for at least one CSI-RS resource of the plurality of CSI-RS resources based on an antenna port configuration configured for the at least one codebook.

18. The method of claim 16, further comprising at least one of:
transmitting a PMI for a CSI-RS resource group based on an antenna ports configuration in the at least one codebook and at least one indicator indicating an antenna combining factor across CSI-RS resources in the CSI-RS resource group; or
transmitting the PMI for the CSI-RS resource group based on each of a plurality of antenna ports configuration for the plurality of CSI-RS resources.

19. (canceled)

20. The method of claim 16, wherein the at least one codebook includes at least one of:
a Type1 single-panel codebook,
a Type1 multi-panel codebook,
a Type2 codebook,
an enhanced Type2 (eType2) codebook, or
a set of codebooks.

21. The method of claim 16, further comprising performing at least one of:
transmitting a PMI for a CSI-RS resource group indicating common spatial domain basis and separate beam combining matrix for each subband for each CSI-RS resources in the CSI-RS resource group;
transmitting the PMI for the CSI-RS resource group indicating common spatial domain basis, common frequency domain basis, and separate beam combining matrix for each CSI-RS resources in the CSI-RS resource group;
transmitting the PMI for the CSI-RS resource group indicating common spatial domain basis, separate frequency domain basis, and separate beam combining matrix for each CSI-RS resources in the CSI-RS resource group; or
transmitting the PMI for the CSI-RS resource group based on a first codebook configuration of a set of codebooks, the first codebook configuration corresponding to the CSI RS resource group.

22. A method for wireless communication at a network entity, the method comprising:
transmitting, via first control signaling to a user equipment (UE), one or more channel state information (CSI) report configurations that indicate a plurality of CSI reference signal (CSI-RS) resources and that configures one or more CSI reports to include port adaptation information, the one or more CSI report configurations including at least one of:
first information configuring a first plurality of codebooks, each of the first plurality of codebooks having a same codebook type, or
second information configuring a second plurality of codebooks having different codebook types;
transmitting the plurality of CSI-RS resources; and
receiving the one or more CSI reports with the port adaptation information, wherein the port adaptation information indicates at least one antenna port configuration and a respective CSI for the at least one antenna port configuration,
wherein the receiving the one or more CSI reports with the port adaptation information includes receiving a first CSI report of the one or more CSI reports, wherein the first CSI report includes a first CSI for the at least one antenna port configuration, and wherein the first CSI report further includes port adaptation information indicating the at least one antenna port configuration.

23. An apparatus, comprising:
a communication unit; and
a processing system configured to control the communication unit to:
receive, via control signaling from a network entity, one or more channel state information (CSI) report configurations that indicate a plurality of CSI reference signal (CSI-RS) resources and that configures one or more CSI reports to include port adaptation information, the one or more CSI report configurations including at least one of:
first information configuring a first plurality of codebooks, each of the first plurality of codebooks having a same codebook type, or
second information configuring a second plurality of codebooks having different codebook types;
receive the plurality of CSI-RS resources;
measure the plurality of CSI-RS resources using a plurality of candidate antenna port configurations; and
transmit the one or more CSI reports with the port adaptation information based on measurements of the plurality of CSI-RS resources, wherein the port adaptation information indicates at least one antenna port configuration and a respective CSI for the at least one antenna port configuration, the one or more CSI reports including at least a first CSI report, wherein the first CSI report includes a first CSI for a first antenna port configuration of the plurality of candidate antenna port configurations, and wherein the first CSI report further includes port adaptation information indicating the first antenna port configuration.

24-25. (canceled)

26. The apparatus of claim 23, wherein the processing system is configured to control the communication unit to transmit at least a second CSI report of the one or more CSI reports, wherein the second CSI report indicates a second antenna port configuration of the plurality of candidate antenna port configurations and includes a second CSI for the second antenna port configuration.
